(19) United States
(12) Patent Application Publication
(10) Pub. No.: US 2026/0268593 A1
(43) Pub. Date: Sep. 10, 2026

(54) SYSTEMS AND METHODS FOR EXTENDED REALITY CONTENT DELIVERY

(71) Applicant: Adeia Guides Inc., San Jose, CA (US)

(72) Inventors: Charles Dasher, Lawrenceville, GA (US); Reda Harb, Saint Petersburg, FL (US); Mathew Adams, Matthews, NC (US); Tao Chen, Palo Alto, CA (US)

(21) Appl. No.: 19/072,152

(22) Filed: Mar. 6, 2025

(51) Int. Cl. G06T 17/00; G06V 10/764; H04N 21/43; H04N 21/6587; H04N 21/845

(52) U.S. Cl. CPC G06T 17/00; G06V 10/764; H04N 21/43072; H04N 21/6587; H04N 21/8456

(57) ABSTRACT

Systems and methods are provided for enabling extended reality content delivery. An input associated with initiating an extended reality scene is received at a computing device, and output of the extended reality scene is initiated. A metadata file indicating a plurality of objects in the extended reality scene is received. The metadata file indicates for each object a plurality of detail levels and a single-use or a multi-use classification. For a single-use object, a first detail level is identified, the single-use object is received at the first detail level and the single-use object is generated for output at the first detail level. For a multi-use object, a second detail level is identified, the multi-use object is received at the second detail level, the multi-use object is stored in a cache at the second detail level and the multi-use object is generated for output at the second detail level.

The present disclosure is generally directed towards systems and methods for extended reality content delivery.

### SUMMARY

With the widespread availability of relatively fast and stable Internet connections and computing devices having relatively high computing power and energy efficiency, the demand for immersive extended reality experiences is growing, with extended reality applications spanning entertainment, education, remote work, and/or social interactions. Current content delivery systems are optimized for linear two-dimensional (2D) video, lacking the capabilities necessary to support the dynamic requirements of extended reality environments. Unlike 2D video, extended reality environments may include interactive three-dimensional (3D) objects and/or complex spatial scenes. Volumetric and spatial 3D video streaming enables users wearing extended reality headsets to view 3D scenes and objects with six degrees of freedom, where an extended reality scene changes in time and interactively; however, this gives rise to relatively high bandwidth requirements and computational processing requirements when compared to 2D video. In addition, the complexity of volumetric video streaming and rendering has posed challenges to their wide adoption. Adaptive bitrate (ABR) streaming protocols, which are commonly used for 2D video, adjust quality based on identified network bandwidth; however, these protocols cannot optimize for the high interactivity and multi-layered data involved in extended reality environments. Extended reality content may need to respond continuously to real-time conditions, adapting, for example, the resolution and detail of both foreground and background elements to create a cohesive, immersive extended reality experience.

Extended reality experiences may comprise 3D objects that may reappear across scenes and/or user interactions. Without efficient caching mechanisms, these objects must be repeatedly downloaded to an extended reality device, leading to redundant data use and potential quality inconsistencies. Traditional streaming protocols may lack the granularity required to cache and progressively enhance multi-use objects across extended reality scenes based on, for example, available bandwidth.

Extended reality trick modes may differ significantly from those in video, as each mode may involve maintaining visual and/or spatial consistency. For example, in a fast-forward mode, selective rendering of keyframes and/or downgrading of background details may need to be utilized to maintain a coherent experience, whereas a pause mode may require detailed, static rendering for user inspection. Existing ABR protocols do not address these needs, causing high data use and/or visual fragmentation in extended reality trick modes.

In the case of the interactive experience of extended reality applications, the adaptation and seamless progression of visual presentation of 3D objects introduce different requirements than in conventional ABR streaming of video. When a user interaction in an extended reality environment requires a real-time response, the extended reality application may closely couple the delivery and presentation of one or more 3D objects in an extended reality environment at an extended reality device with primary media content, such as a content item, at an associated smart television in low latency manner.

Considering the challenges in streaming an expected quality of 3D assets, or objects, in an extended reality environment, coherent and ordered progression of quality of the objects may be desirable. This differs, for example, from the quality adaptation in ABR streaming, where changes are applied through requesting different bitrates or resolutions.

To help address these problems, systems and methods are provided for extended reality content delivery.

In accordance with a first aspect of the disclosure, a method for enabling extended reality content delivery is provided. A plurality of virtual objects are identified at a first computing device and, for each object of the plurality of virtual objects, a plurality of detail levels and a single-use or a multi-use classification is identified. A metadata file is generated for the plurality of virtual objects, where the metadata file indicates, for each object of the plurality of virtual objects, the plurality of detail levels, a location of the object for each detail level of the plurality of detail levels and the single-use or the multi-use classification. The metadata file is stored, and the metadata file is caused to be retrieved by a second computing device. The second computing device is caused to retrieve at least a subset of the plurality of virtual objects at a detail level of the plurality of detail levels, and the subset of the plurality of virtual objects is caused to be generated for output.

In an example system, a plurality of objects of a virtual reality environment are identified at a server. In some examples, the virtual reality environment may be associated with a content item, such as a television program, that may be consumed at a computing device such as a smart television. The virtual environment may comprise a plurality of different scenes and, depending on whether an object appears in multiple scenes, each object of the plurality of objects may be designated as single-use or multi-use. In addition, different detail levels may be identified for each object, for example, a low-quality version, a middle-quality version and a high-quality version. A metadata file is generated at the server for the plurality of virtual objects, wherein the metadata file indicates, for each object of the plurality of virtual objects, the plurality of detail levels, a URL of the object for each detail level of the plurality of detail levels and the single-use or the multi-use classification. The metadata file is stored at the server, and the metadata file is caused to be retrieved by an extended reality device, for example, via a network such as the Internet. The extended reality device is caused to retrieve at least a subset of the plurality of virtual objects at a high detail level, for example, based on a network bandwidth that is capable of delivering the virtual objects at a high detail level being available to the extended reality device, and the received subset of the plurality of virtual objects is caused to be generated for output at the extended reality device.

In accordance with a second aspect of the disclosure, a method for enabling extended reality content delivery is provided. An input associated with initiating an extended reality scene is received at a computing device, and output of the extended reality scene is initiated at the computing device. A metadata file indicating a plurality of objects in the extended reality scene is received at the computing device. The metadata file indicates, for each object of the plurality of objects, a plurality of detail levels and a single-use classification or a multi-use classification. For a single-use object of the plurality of objects having the single-use classification, a first detail level of the plurality of detail levels is identified; the single-use object is received at the first detail level; and the single-use object is generated for output at the first detail level. For a multi-use object of the plurality of objects having the multi-use classification, a second detail level of the plurality of detail levels is identified; the multi-use object is received at the second detail level; the multi-use object is stored in a cache at the second detail level; and the multi-use object is generated for output at the second detail level.

In an example system, a hand gesture associated with initiating an extended reality scene is received at an extended reality device, and output of the extended reality scene is initiated at the extended reality device. A hand gesture may be, for example, a predetermined hand gesture that is linked with initiating the extended reality scene. A user may draw a predefined symbol with a hand that is detected and interpreted by the extended reality device. In another example, a user may select a virtual icon associated with an initiated the extended reality scene by making a pinching gesture associated with the icon. In another example, the extended reality scene may be initiated via an input received via an input device connected to the extended reality device. A metadata file indicating a plurality of objects in the extended reality scene is received at the extended reality device. The metadata file indicates, for each object of the plurality of objects, a plurality of detail levels and a single-use classification or a multi-use classification. For a single-use object of the plurality of objects having the single-use classification, a low detail level is identified based on a network bandwidth available to the extended reality device; the single-use object is received at the low detail level; and the single-use object is generated for output at the extended reality device at the low detail level. For a multi-use object of the plurality of objects having the multi-use classification, a low detail level is identified based on a low network bandwidth available to the extended reality device; the multi-use object is received at the low detail level; the multi-use object is stored in a cache at the low detail level; and the multi-use object is generated for output at the low detail level. In some examples, the extended reality device may identify whether the available bandwidth can support a particular detail level for an object, and the extended reality device may select the highest level of detail that the available bandwidth can support. This determination may include, for example, an additional amount of bandwidth, as headroom, to prevent the delivery of the object from taking up all of the available bandwidth.

### BRIEF DESCRIPTIONS OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

The above and other objects and advantages of the disclosure may be apparent upon consideration of the following detailed description, taken in conjunction with the accompanying drawings, in which:

FIG. 1 shows a schematic diagram of a system for enabling extended reality content delivery, in accordance with some embodiments of the disclosure;

FIG. 2 shows another schematic diagram of a system for enabling extended reality content delivery, in accordance with some embodiments of the disclosure;

FIG. 3 shows a sequence diagram of illustrative steps for enabling extended reality content delivery, in accordance with some embodiments of the disclosure;

FIG. 4 shows another sequence diagram of illustrative steps for enabling extended reality content delivery, in accordance with some embodiments of the disclosure;

FIG. 5 shows another sequence diagram of illustrative steps for enabling extended reality content delivery, in accordance with some embodiments of the disclosure;

FIG. 6 shows another sequence diagram of illustrative steps for enabling extended reality content delivery, in accordance with some embodiments of the disclosure;

FIG. 7 shows another sequence diagram of illustrative steps for enabling extended reality content delivery, in accordance with some embodiments of the disclosure;

FIG. 8 shows another sequence diagram of illustrative steps for enabling extended reality content delivery, in accordance with some embodiments of the disclosure;

FIG. 9 shows another sequence diagram of illustrative steps for enabling extended reality content delivery, in accordance with some embodiments of the disclosure;

FIG. 10 shows another sequence diagram of illustrative steps for enabling extended reality content delivery, in accordance with some embodiments of the disclosure;

FIG. 11 shows a schematic diagram of different detail levels of an object of an extended reality scene in accordance with some embodiments of the disclosure;

FIG. 12 shows another sequence diagram of illustrative steps for enabling extended reality content delivery, in accordance with some embodiments of the disclosure;

FIG. 13 shows a schematic manifest for enabling extended reality content delivery, in accordance with some embodiments of the disclosure;

FIG. 14 shows a flowchart of illustrative steps for enabling extended reality content delivery, in accordance with some embodiments of the disclosure;

FIG. 15 shows another flowchart of illustrative steps for enabling extended reality content delivery, in accordance with some embodiments of the disclosure;

FIG. 16 shows an example metadata file in accordance with some embodiments of the disclosure;

FIG. 17 shows another flowchart of illustrative steps for enabling extended reality content delivery, in accordance with some embodiments of the disclosure;

FIG. 18 shows another flowchart of illustrative steps for enabling extended reality content delivery, in accordance with some embodiments of the disclosure;

FIG. 19 shows another flowchart of illustrative steps for enabling extended reality content delivery, in accordance with some embodiments of the disclosure;

FIG. 20 shows another flowchart of illustrative steps for enabling extended reality content delivery, in accordance with some embodiments of the disclosure;

FIG. 21 shows another flowchart of illustrative steps for enabling extended reality content delivery, in accordance with some embodiments of the disclosure;

FIG. 22 shows another flowchart of illustrative steps for enabling extended reality content delivery, in accordance with some embodiments of the disclosure;

FIG. 23 shows another flowchart of illustrative steps for enabling extended reality content delivery, in accordance with some embodiments of the disclosure;

FIG. 24 shows another flowchart of illustrative steps for enabling extended reality content delivery, in accordance with some embodiments of the disclosure;

FIG. 25 shows a block diagram representing components of a computing device and dataflow therebetween for enabling extended reality content delivery, in accordance with some embodiments of the disclosure; and

FIG. 26 shows another block diagram representing components of a computing device and dataflow therebetween for enabling extended reality content delivery, in accordance with some embodiments of the disclosure.

### DETAILED DESCRIPTION

At a high level, the examples discussed herein may be directed towards a system comprising a computing device, such as a smart television, that outputs a content item and an extended reality device that outputs an extended reality environment which is associated with the content item. A user may watch a content item on the smart television while also wearing an extended reality device that outputs an extended reality environment associated with the content item in order to provide an enhanced viewing experience. The extended reality environment may comprise one or more scenes that may correspond to different scenes in the content item. In another example, the extended reality environment may comprise one or more scenes that correspond to additional content such as, for example, replays, different camera angles and/or advertisements. Each scene in the extended reality environment may comprise one or more objects (or assets) that are output at the extended reality device.

An extended reality device includes any computing device that is capable of generating and displaying computer-generated or rendered objects and/or information in a manner consistent with virtual reality, augmented reality and/or mixed reality. Typically, these devices are head-mounted and project images relatively close to a user's eyes. A virtual reality device is one that typically creates a virtual 3D environment for a user to explore including, for example, the Meta Quest and the Valve Index. An augmented reality device is one that typically enables users to view images superimposed onto the real environment including, for example, applications running on a smartphone that superimpose objects onto a surrounding real environment via a camera and display at the smartphone. A mixed reality device is one that typically combines virtual reality and augmented reality, enabling a user to interact with both physical and virtual objects and environments including, for example, the Microsoft HoloLens and the Magic Leap One.

An extended reality scene includes any group of objects, or assets, generated at an extended reality device for output. An extended reality scene may correspond to a scene of a content item being output at a smart television. In some examples, the scenes and/or objects may be synchronized with the content item being output at the smart television. An extended reality environment may comprise a group of extended reality scenes and objects.

An object, or asset, of an extended reality scene includes any virtual object generated by an extended reality device for the extended reality scene. An object may be received from a server via a network such as the Internet. A metadata file and/or a manifest file may provide details and/or instructions about where the objects can be retrieved from (e.g., via a uniform resource locator (URL)) and how they are presented in the extended reality scene. In some examples, multiple metadata and/or manifest files may be associated with a single extended reality scene. Examples of objects may include, for example, characters and/or key props in an extended reality scene.

An object may be made available at different levels of detail (e.g., high, medium and/or low) that correspond to different available bandwidths and/or availability of computing resources at the extended reality device. In some examples, the object may be stored in a cache (e.g., in volatile and/or non-volatile memory) at the extended reality device and/or at a device available on a local network to which the extended reality device is connected. In some examples, an extended reality device and/or an application implementing an extended reality environment is configured to interpret the instructions to cache and/or not cache an extended reality object at the extended reality device based on the object being multi-use and/or single-use. For example, a time-to-live may be associated with an object and used to determine how long to store the object in a cache at the extended reality device.

A content item includes audio, video, text, a video game and/or any other media content. A content item may be a single media item. In other examples, it may be a series (or season) of episodes of related content items. Video includes audiovisual content such as movies and/or television programs or portions thereof. Audio includes audio-only content, such as podcasts or portions thereof, audio description for a segment associated with the media item, etc. Text includes text-only content, such as event descriptions, closed caption, subtitles, or portions thereof.

The disclosed methods and systems may be implemented on one or more devices, such as user device, client devices and/or computing devices. As referred to herein, the device can be any device comprising a processor and memory, for example, a server, a handheld computer, a mobile telephone, a portable video player, a portable music player, a portable gaming machine or console, a smartphone, a smartwatch, a smart speaker, an augmented reality headset, a mixed reality device, a virtual reality device, a gaming console, a vehicle infotainment headend or any other computing equipment, wireless device, and/or combination of the same.

The methods and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory, including, but not limited to, volatile and non-volatile computer memory or storage devices such as a hard disk, USB drive, DVD, CD, media cards, register memory, processor caches, random access memory (RAM) and/or a solid-state drive.

The examples herein are directed at systems and methods for adaptive extended reality content delivery that dynamically manages levels of detail for 3D objects, scenes and/or video segments. For a video segment, a level of detail may be, for example, different bitrates and/or resolutions of a video segment. A level of detail selection of an object in an extended reality scene may take into account bandwidth conditions of a network connection (including real-time bandwidth conditions), the file size of an object or scene, whether an object is designated at single-use or multi-use, a caching strategy, any trick mode requirements and/or fallback options in low-bandwidth and/or unreliable bandwidth situations. Technical advantages of the examples described herein include optimization of data usage, maintaining high visual fidelity and/or supporting fluid user interactions across diverse network and computing device conditions.

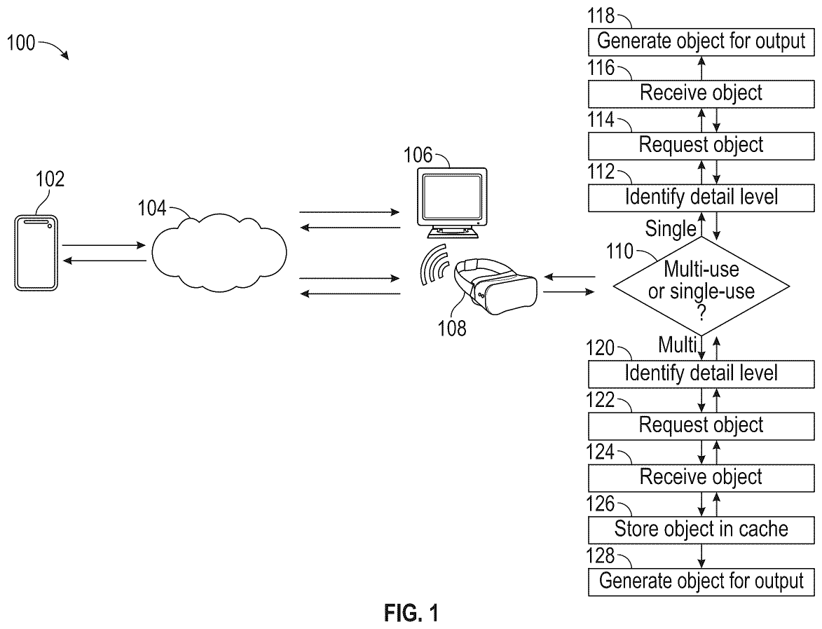

FIG. 1 shows a schematic diagram of a system for enabling extended reality content delivery, in accordance with some embodiments of the disclosure. The environment 100 comprises a server 102, a network 104, a first computing device such as a smart television 106 and a second computing device such as an extended reality device 108. The server 102 may be a single server or may comprise a plurality of servers. In some examples, the server 102 may comprise a plurality of physical and/or virtual servers. The network 104 may be any network, such as the Internet, and may comprise wired and/or wireless means. The smart television 106 receives a content item, such as a movie or television program, from the server 102 via the network 104, and the extended reality device 108 receives an extended reality scene associated with the content item from the server 102. Typically, the extended reality scene comprises a plurality of objects, each of which may be single-use (i.e., received and output) or multi-use (i.e., received, stored at the extended reality device 108 and output multiple times).

The extended reality device 108 receives a metadata file indicating a plurality of objects in the extended reality scene. Typically, the metadata file indicates, for each object of the plurality of objects, a plurality of detail levels and a single-use classification or a multi-use classification. At 110, the extended reality device 108 determines whether the object is a single-use object or a multi-use object. This determination may be based on the received metadata file that indicates the single-use or multi-use classification of the object.

For a single-use object, the extended reality device 108 identifies a detail level 112, for example, based on a bandwidth available to the extended reality device 108. In some examples, the extended reality device may identify whether the available bandwidth can support a particular detail level for a single-use object, and the extended reality device may select the highest level of detail that the available bandwidth can support. This determination may include, for example, an additional amount of bandwidth, as headroom, to prevent the delivery of the object from taking up all of the available bandwidth. At 114, the object is requested at the identified detail level. This may be, for example, from the server 102 via a URL identified in the metadata file. At 116, the object is received at the identified detail level from the server 102 and, at 118, the object is generated for output at the extended reality device 108.

For a multi-use object, the extended reality device 108 identifies a detail level 120, for example, based on a bandwidth available to the extended reality device 108. In some examples, the extended reality device may identify whether the available bandwidth can support a particular detail level for a multi-use object, and the extended reality device may select the highest level of detail that the available bandwidth can support. This determination may include, for example, an additional amount of bandwidth, as headroom, to prevent the delivery of the object from taking up all of the available bandwidth. This may be, for example, from the server 102 via a URL identified in the metadata file. At 124, the object is received at the identified detail level from the server 102 and, at 126, the object is stored in a cache, for example, at the extended reality device 108. At 128, the object is generated for output at the extended reality device 108, for example, after being retrieved from the cache.

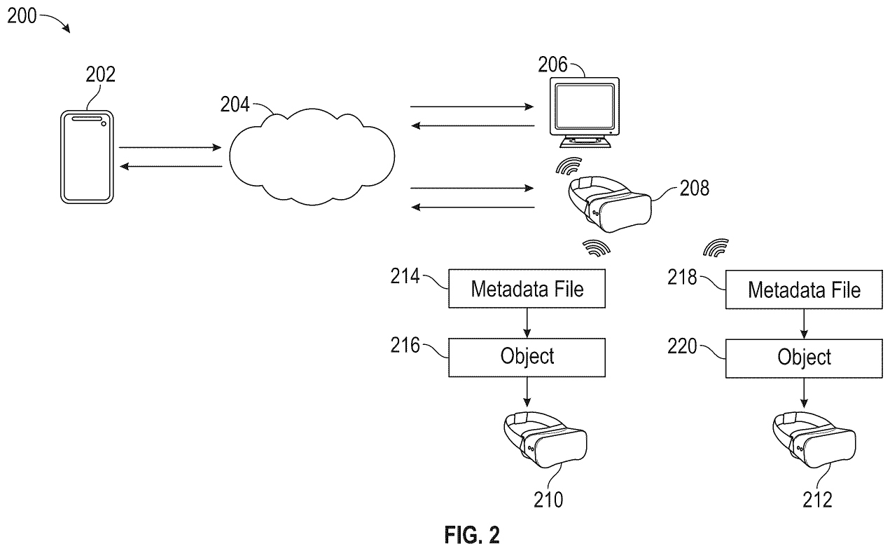

FIG. 2 shows another schematic diagram of a system for enabling extended reality content delivery, in accordance with some embodiments of the disclosure. The environment 200 comprises a server 202, a network 204, a first computing device such as a smart television 206, a second computing device such as a first extended reality device 208, a third computing device such as a second extended reality device 210 and a fourth computing device such as a third extended reality device 212. The server 202 may be a single server or may comprise a plurality of servers. In some examples, the server 202 may comprise a plurality of physical and/or virtual servers. The network 204 may be any network, such as the Internet, and may comprise wired and/or wireless means. The smart television 206 receives a content item, such as a movie or television program, from the server 202 via the network 204, and the extended reality device 208 receives an extended reality scene associated with the content item from the server 202. Typically, the extended reality scene comprises a plurality of objects, each of which may be single-use (i.e., received and output) or multi-use (i.e., received, stored at the extended reality device 108 and output multiple times). In this example, the second and third extended reality devices 210, 212 receive extended reality objects from the first extended reality device 208. This is enabled by the first extended reality device 208 transmitting a metadata file 214, 218 to the respective second and third extended reality devices 210, 212 via a local network, such as a Wi-Fi network. The metadata file 214, 218 transmitted to the second and third extended reality devices 210, 212 may be the same metadata file 214, 218. In another example, the metadata file 214, 218 transmitted to the second and third extended reality devices 210, 212 may be different metadata files 214, 218. In some examples, the server 202 may transmit the metadata file to the second and third extended reality devices 210, 212 via the network 204. In further examples, the server may determine the presence of the first extended reality device 208 before dynamically generating the metadata files 214, 218 for transmission to the second and third extended reality devices 210, 212. In this example, the metadata files 214, 218 may be configured to point to the first extended reality device 208 as a source for the objects in response to determining that the first extended reality device is present. In some examples, additional, remote locations (such as other servers) may be indicated as backup (or fallback) sources for retrieving the objects in, for example, an event where the first extended reality device 208 is not available or is temporarily unavailable. The second and third extended reality devices 210, 212 request and receive virtual objects 216, 220 from the first extended reality device 208.

In an example, the system may enable an adaptive level of detail selection for both 3D objects in an extended reality scene and video assets based on, for example, real-time network bandwidth, object designation as single-use or multi-use, caching strategies, trick mode requirements, and/or low-bandwidth fallback conditions. For a video segment, a level of detail may be, for example, different bitrates and/or resolutions of a video segment. In some examples, a manifest, such as an ABR manifest, may specify multiple levels of detail for each 3D scene, object, and/or video segment, enabling a client system to dynamically select the most appropriate detail level based on, for example, the aforementioned factors. This example may enable more important (or essential) elements, or objects, in an extended reality scene to be rendered in the highest quality available, while less important (or non-essential) elements, or objects, in the extended reality scene may be rendered at lower detail levels to, for example, optimize bandwidth and/or processing resource usage.

In some examples, a system may continuously monitor network bandwidth and device capabilities. For example, if the available bandwidth to a computing device (such as a client computing device) increases, the computing device may progressively fetch an object for an extended reality scene at higher levels of detail. In another example, if the available bandwidth to a computing device drops, the system may selectively downgrade the levels of detail of objects in an extended reality scene, starting with background elements and objects tagged as low priority. This may, for example, enable seamless interaction while minimizing the impact on the visual quality of a scene. The manifest may also include data indicating fallback versions of critical assets, or objects, that are pre-fetched at the computing device at a lower level of detail than a non-fallback version of the object. This may, for example, enable a smooth transition when network fluctuations occur. A technical advantage of this example is that of enabling the delivery of a cohesive and efficient extended reality experience across varying network conditions.

The example below details metadata with multiple levels of detail specified for either video segments and/or 3D scenes. This configuration supports, for example, the real-time selection of the appropriate levels of detail based on available bandwidth to a computing device, with pre-fetched fallback options for use in low-bandwidth conditions. Timecode triggers are included to enable scene transitions at specific timestamps within the video.

The following is an example pseudo-metadata file that may be loaded by, for example, a streaming video player. In this example, a primary computing device, such as a smart television, may initiate content item playback by downloading an initial manifest (such as an ABR manifest) to deliver two-dimensional video content. The smart television may utilize this manifest to optimize video quality based on, for example, network conditions and/or device capabilities. This may comprise, for example, the smart television determining which segment variation to fetch based on the network conditions and/or device capabilities. The user may operate the smart television via a remote control, enabling functions such play, pause, rewind, and fast-forward. When content item playback is initiated on the smart television, the initial manifest file may trigger a connected extended reality headset (or device) to retrieve corresponding metadata via, for example, a local network such as a Wi-Fi network. The television manifest may specify, for example, a unique identifier associated with the content item, a duration of the content item and/or media sequence points to enable real-time synchronization between the content item being displayed at the smart television and the extended reality scene being displayed at the extended reality headset. An example pseudo-manifest enabling this is as follows:

```
{
  “contentId”: “media_001”,
  “duration”: “01:30:00”,
  “mediaSequence”: [
    {
      “timestamp”: “00:00:00”,
      “action”: “start”,
      “targetDevice”: “XR_headset”,
      “metadataTrigger”.
    “https://cdn.example.com/xr_metadata/media_001_metadata.json”
    }
  ]
}
```

Continuing the example, the extended reality headset may then access the specified metadata, which may define detailed instructions for rendering 3D elements, or objects, of an extended reality scene, managing levels of detail based on network conditions, and/or coordinating trick modes to match the playback state of the content item at the smart television. The extended reality headset may be opted in to an immersive session with the content item being displayed at the smart television via, for example, a selection of a user interface element from within the extended reality device itself or through a selection of a user interface element at the smart television. An example of extended reality pseudo-metadata enabling this is as follows, with an object level of detail being referred to as LoD:

```
{
  “id”: “media_001_metadata”,
  “type”: “XR3DScene”,
  “syncSettings”: {
    “sceneObjects”: [
      {
        “id”: “objectA”,
        “name”: “BackgroundBuilding”,
        “fileSize”: “3MB”,
        “downloadTime”: “5s”,
        “use”: “single-use”,
        “cache”: “no”,
        “LoD”: [
          { “fileSize”: “3MB”, “complexity”: “low” },
          { “fileSize”: “7MB”, “complexity”: “medium” }
        ]
      },
      {
        “id”: “objectB”,
        “name”: “RecurringCharacter”,
        “fileSize”: “2MB”,
        “downloadTime”: “3s”,
        “use”: “multi-use”,
        “cache”: “yes”,
        “progressiveUpgrade”: [
          { “fileSize”: “2MB”, “downloadTime”: “3s”, “complexity”:
        “low” },
          { “fileSize”: “6MB”, “downloadTime”: “8s”, “complexity”:
        “medium” },
          { “fileSize”: “10MB”, “downloadTime”: “15s”,
        “complexity”: “high” }
        ]
      }
    ],
    “trickModeSettings”: {
      “fastForward”: {
        “renderingMode”: “selective”,
        “objectPriorities”: “foregroundOnly”
      },
      “pause”: {
        “renderingMode”: “highDetail”,
        “focusObjects”: [“RecurringCharacter”]
      }
    }
  }
}
```

In an example, a specialized ABR packager is employed to deliver synchronized media content for both traditional ABR video playback and immersive extended reality experiences. In some examples, this may effectively coordinate these elements within a single unified package. The ABR packager may, for example, prepare segmented video content alongside extended reality-specific metadata, object files, and/or scene descriptors. This may, for example, enable adaptive streaming of different media types in a synchronized manner. File size, scene complexity and/or predicted download time may be utilized to optimize an extended reality experience without depending solely on bitrate segmentation. The packager may be designed to efficiently bundle video and extended reality content, segmenting and preparing each asset type according to different performance parameters suited to real-time conditions. This may, for example, provide a robust solution for delivering both linear and interactive media (i.e., an extended reality scene) in a cohesive format.

In an example, the ABR packager may initially prepare a linear video stream, segmenting the content into various qualities to enable adaptable playback based on, for example, a network environment and/or device capabilities. Alongside the video, the packager may process extended reality metadata and/or associated objects and/or scenes by creating a multi-tiered approach to file preparation. Each extended reality object and/or scene may be segmented by file size (rather than, for example, bitrate), anticipated download time and/or scene complexity. Together this enables, for example, flexible delivery that responds to real-time network bandwidth. The packager may use these characteristics to create a tailored approach for each object and/or scene. This may enable the packager to provide multiple versions and/or levels of detail for an object of an extended reality scene that are progressively enhanced as, for example, bandwidth allows. This may, for example, enable a smooth user experience without compromising immersion.

The packager may include synchronization points in the manifest (such as an ABR manifest), which may act as triggers to notify the extended reality device when corresponding metadata and/or 3D objects (of an extended reality scene) should load in order to remain in synchronization with the video content playing on a primary device such as a smart television. Each synchronization point may mark where extended reality metadata should be accessed and/or loaded, which enables the extended reality device to retrieve relevant instructions for rendering immersive elements (i.e., objects of an extended reality scene) in synchronization with the primary media content (i.e., a content item being displayed on the smart television). This system may rely on a structured metadata format, such as JavaScript object notation (JSON) or extensible markup language (XML), to define scene-specific instructions, options for progressive levels of detail and/or caching preferences based on, for example, file size and/or download time. This may enable the extended reality experience to remain visually cohesive without placing excessive demands on the network connecting the extended reality device to the server delivering the objects of the extended reality scene.

For real-time adaptability, the packager may segment extended reality objects and/or scenes by multiple level of detail options, enabling them to load progressively based on file size, estimated download time and/or scene complexity. As network bandwidth (i.e., the network connecting the extended reality device to the server delivering the objects of the extended reality scene) fluctuates, the extended reality device may select the most appropriate level of detail for an object. The level of detail may range from lower-resolution files for low-bandwidth scenarios to higher fidelity versions where, for example, network conditions allow. Each extended reality asset may also be tagged as either single-use or multi-use, with single-use objects being downloaded for the single-use and discarded after, for example, appearing in an extended reality scene, while multi-use objects may be cached, for example, at the extended reality device and, in some examples, progressively upgraded for reuse in multiple extended reality scenes. In some examples, a single-use object may be temporarily cached until the beginning of a new extended reality scene and/or until objects begin loading for a new extended reality scene to, for example, enable a rewind command to be processed without needed to redownload the objects. In another example, single-use objects may be temporarily cached for a session (i.e., for example, until the extended reality device is turned off or enters a standby mode) again, for example, to enable a rewind command to be processed without needed to redownload the objects. This segmentation by use designation and complexity may enable efficient memory and bandwidth management, as multi-use objects remain in the device cache and may be progressively updated to higher levels of detail whenever, for example, network conditions permit.

The resulting unified ABR manifest generated by the packager may combine both video and extended reality metadata, with segments aligned in a structured sequence that enables either content item video and/or the extended reality objects to be accessed as needed for synchronized playback. For example, the manifest may comprise references to specific extended reality metadata files and/or objects alongside content item video segments. The manifest may designate objects of an extended reality scene as multi-use. The manifest may also comprise caching instructions for the multi-use objects. In some examples, the manifest may also comprise synchronization markers to enable the extended reality elements to load and/or adjust their level of detail in synchronization with the content item video timeline. In some examples, the manifest may comprise one or more trick mode settings to enable the extended reality content to respond to video playback functions such as fast-forward, rewind and/or pause. For example, if the content item is fast-forwarded on a primary video screen (e.g., at a smart television), the extended reality device may adjust the output of the extended reality scene by selectively rendering only high-priority objects (for example those designated as high-priority in the manifest) and/or foreground elements. This may, for example, reduce resource usage at the extended reality device. In some examples, if the content item video is paused, the extended reality device may load high-fidelity assets (i.e., objects) for one or more focal elements. This may enable close inspection by a user without compromising bandwidth. The following is an example pseudo-output of the packager described above, with an object level of detail being referred to as LoD:

```
{
  “manifestVersion”: “1.1”,
  “contentId”: “session_001”,
  “mediaDuration”: “01:30:00”,
  “security”: {
    “drm”: {
      “type”: “widevine”,
      “licenseUrl”: “https://cdn.example.com/license”
    },
    “encryption”: “#AES-256”
  },
  “segments”: [
    {
      “type”: “video”,
      “qualityLevels”: [
        {
          “url”:
        “https://cdn.example.com/media/session_001_480p.mp4”,
          “fileSize”: “30MB”,
          “estimatedDownloadTime”: “5s”,
          “resolution”: “480p”
        },
        {
          “url”:
        “https://cdn.example.com/media/session_001_720p.mp4”,
          “fileSize”: “50MB”,
          “estimatedDownloadTime”: “10s”,
          “resolution”: “720p”
        },
        {
          “url”:
          “https://cdn.example.com/media/session_001_1080p.mp4”,
          “fileSize”: “100MB”,
          “estimatedDownloadTime”: “20s”,
          “resolution”: “1080p”
        }
      ],
      “segmentDuration”: “10s”,
      “syncPoint”: “00:00:00”
    },
    {
      “type”: “xr_metadata”,
      “contentUrl”: “https://cdn.example.com/xr/scene1_metadata.json”,
      “estimatedDownloadTime”: “2s”,
      “syncPoint”: “00:00:10”},
    {
      “type”: “xr_object”,
      “id”: “objectA”,
      “name”: “BackgroundBuilding”,
      “fileSize”: “3MB”,
      “downloadTime”: “5s”,
      “use”: “single-use”,
      “cache”: “no”,
      “LoD”: [
        {
          “fileSize”: “3MB”,
          “complexity”: “low”,
          “estimatedDownloadTime”: “5s”
        },
        {
          “fileSize”: “7MB”,
          “complexity”: “medium”,
          “estimatedDownloadTime”: “12s”
        }
      ],
      “fallback”: “https://cdn.example.com/xr/scene1_background_
      fallback.glb”
    },
    {
      “type”: “xr_object”,
      “id”: “objectB”,
      “name”: “RecurringCharacter”,
      “fileSize”: “2MB”,
      “downloadTime”: “3s”,
      “use”: “multi-use”,
      “cache”: “yes”,
      “progressiveLevels of detail”: [
        {
          “fileSize”: “2MB”,
          “complexity”: “low”,
          “estimatedDownloadTime”: “3s”
        },
        {
          “fileSize”: “6MB”,
          “complexity”: “medium”,
          “estimatedDownloadTime”: “8s”,
          “condition”: “downloadSpeed > 5Mbps”
        },
        {
          “fileSize”: “10MB”,
          “complexity”: “high”,
          “estimatedDownloadTime”: “15s”,
          “condition”: “downloadSpeed > 10Mbps”
        }
      ],
      “fallback”: “https://cdn.example.com/xr/character_fallback.glb”
    },
    {
      “type”: “xr_scene”,
      “contentUrl”: “https://cdn.example.com/xr/scene2_metadata.json”,
      “estimatedDownloadTime”: “3s”,
      “syncPoint”: “00:05:00”,
      “dynamicLevels of detailAdjustments”: {
        “lowBandwidthTrigger”: “500kbps”,
        “highBandwidthTrigger”: “3000kbps”
      }
    }
  ],
  “trickModeSettings”: {
    “fastForward”: {
      “renderingMode”: “selective”,
      “targetObjects”: [“foregroundOnly”],
      “frameRateAdjustment”: “reduced”,
      “skipLessCriticalElements”: true
    },
    “rewind”: {
      “renderingMode”: “reducedLevels of detail”,
      “LoDTarget”: “low”,
      “preFetchRange”: “10s”
    },
    “pause”: {
      “renderingMode”: “highDetail”,
      “focusObjects”: [“multi-use”],
      “backgroundLoad”: “deferred”
    }
  },
  “errorHandling”: {
    “objectLoadFailure”: {
      “action”: “loadFallback”,
      “retry Attempts”: 2
    },
    “networkIssues”: {
      “lowBandwidthAction”: “switchToLevels of detail low”,
      “highLatencyAction”: “reduceSegmentSize”
    }
  },
  “deviceSpecificSettings”: {
    “deviceType”: “XR_headset”,
    “gpuStrength”: “medium”,
    “maxResolution”: “720p”,
    “adjustments”: {
      “scaleDownHighLevels of detail”: true, “enableSelectiveCaching”:
      true
    }
  }
}
```

In this example, a client computing device, such as an extended reality device, may select the best-suited level of detail for each object and/or video segment based on, for example, the real-time bandwidth and/or other factors. The other factors may include, for example, whether the asset, or object, of an extended reality scene is single-use or multi-use. Multi-use assets may be cached, for example, at the extended reality device for reuse in future scenes. This may enable, for example, a reduction in the need for re-downloading the objects. In, for example, low-bandwidth conditions, a fallback option may be used to enable continuity without interrupting the extended reality experience.

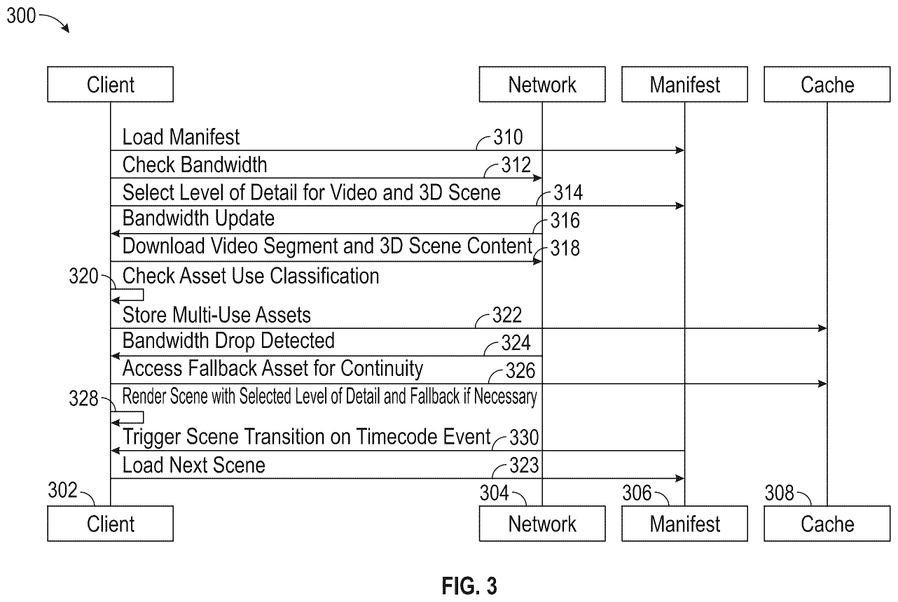

FIG. 3 shows a sequence diagram of illustrative steps for enabling extended reality content delivery, in accordance with some embodiments of the disclosure. Process 300 may be implemented, in whole or in part, on any of the computing devices mentioned herein. In addition, one or more actions of the process 300 may be incorporated into or combined with one or more actions of any other processes, embodiments or examples described herein.

The process 300 comprises a client computing device 302, a network 304, a manifest 306 and a cache 308 of the client computing device 302. In some examples, the manifest 306 is an ABR manifest. The process describes receiving video of a content item, such as a movie and/or a television program and an extended reality scene. Typically, the video comprises segments of different qualities (e.g., different resolutions and/or different bitrates). The segments are identified in the manifest file 306, and each segment of the video identified and delivered at a quality level that is suitable for, for example, the network conditions. In addition, the extended reality scene, in this example, a 3D scene, comprises content, i.e., assets, that is also received. The assets are available in different levels of detail, and each asset of the scene is identified and delivered at a detail level that is suitable for, for example, the network conditions.

At 310, the manifest 306 is loaded at the client computing device 302 and, at 312, the available network 304 bandwidth is checked. At 314, a level of quality for a video and a level of detail for a 3D scene are selected, typically, based on the network 304 bandwidth from step 312. At step 316, the available network 304 bandwidth is updated and, at 318, a video segment and 3D scene content are downloaded at the respective selected levels of quality and detail. At 320, an asset use classification is checked, for example, whether an asset is single-use or multi-use and, at step 322, multi-use assets are stored in the cache 308. At 324, a drop in network 304 bandwidth is detected and, at 326, a fallback asset is accessed in order to provide continuity. At 328, a scene is rendered with the content at the selected level of detail and, if necessary, the fallback asset. At step 330, a scene transition is triggered on an identified timecode event. At 323, a next scene is loaded.

In an example, the system may handle multi-use objects of an extended reality scene by caching the objects upon an initial download. The multi-use objects may be progressively upgraded (i.e., by downloading higher levels of detail for that object) based on, for example, bandwidth availability to an extended reality device. The manifest, such as an ABR manifest, may designate each asset, or object, as either single-use or multi-use. The designation may enable the client, such as an extended reality device, to determine whether an object should be cached for reuse (i.e., a multi-use object) in future scenes or discarded after use during a session (i.e., a single-use object). In some examples, a single-use object may be retained for a session, an extended reality scene and/or until local storage is required for a multi-use object. For multi-use objects, the client, such as an extended reality device, may initially download the asset, or object, at an appropriate level of detail based on, for example, a real-time bandwidth available to the extended reality device, and the extended reality device may cache it for future scenes. Where there is available bandwidth, for example, as network conditions improve and/or where the system is not utilizing all of the available bandwidth, the system may progressively update cached multi-use objects to higher levels of detail (i.e., by downloading higher levels of detail for the cached objects as bandwidth permits). This may enable visual consistency across scenes to be maintained while avoiding redundant downloads.

The aforementioned example may aid extended reality applications with recurring elements, or objects, such as primary characters, props and/or background elements, in an extended reality scene. These recurring objects may need to persist visually across different contexts. For example, as a user navigates an extended reality environment comprising multiple scenes, the system may reuse cached multi-use objects, downloading only incremental updates to achieve a higher resolution (or level of detail) when bandwidth available to the extended reality device allows. The following example manifest segment (for example, an HTTP live streaming (HLS) manifest) defines a multi-use 3D object with specified levels of detail and caching instructions. The example manifest includes video segments associated with the object's initial context and progressively higher levels of detail for use across different scenes of an extended reality environment.

```
{
  “id”: “object1”,
  “type”: “XR3DObject”,
  “name”: “PersistentObject”,
  “videoSegments”: [
    {
      “bitrate”: “500kbps”,
      “url”: “https://cdn.example.com/video/object_intro_500kbps.mp4”,
      “timecodeStart”: “00:00:00”,
      “timecodeEnd”: “00:02:00”
    },
    {
      “bitrate”: “1500kbps”,
      “url”: “https://cdn.example.com/video/object_intro_1500kbps.mp4”,
      “timecodeStart”: “00:00:00”,
      “timecodeEnd”: “00:02:00”
    },
    {
      “bitrate”: “3000kbps”,
      “url”: “https://cdn.example.com/video/object_intro_3000kbps.mp4”,
      “timecodeStart”: “00:00:00”,
      “timecodeEnd”: “00:02:00”
    }
  ],
  “levelsOfDetail”: [
    {
      “bitrate”: “500kbps”,
      “url”: “https://cdn.example.com/xr/object_lo.glb”,
      “cache”: “yes”,
      “use”: “multi-use”
    },
    {
      “bitrate”: “1500kbps”,
      “url”: “https://cdn.example.com/xr/object_med.glb”,
      “cache”: “yes”,
      “use”: “multi-use”
    },
    {
        “bitrate”: “3000kbps”,
        “url”: “https://cdn.example.com/xr/object_hi.glb”,
        “cache”: “yes”,
        “use”: “multi-use”
    }
  ],
  “progressiveUpgrade”:
    “enabled”: “yes”,
    “upgradeConditions”: [“bandwidth > 2000kbps”]
  }
}
```

In this example, the object is designated as multi-use, and caching is designated as enabled; by caching the object at the extended reality device, it can be retained for different extended reality scenes at the extended reality device without the object needing to be re-downloaded. In this example, the “progressiveUpgrade” designation instructs the client, or extended reality device, to fetch (i.e., download) higher level of detail versions of the object as, for example, available bandwidth permits. This may enable smooth, incremental upgrades of the object detail without a requiring full re-download of the object. This caching and upgrade mechanism may enable objects to be used across multiple scenes while retaining relatively high visual fidelity and also reducing latency in re-rendering.

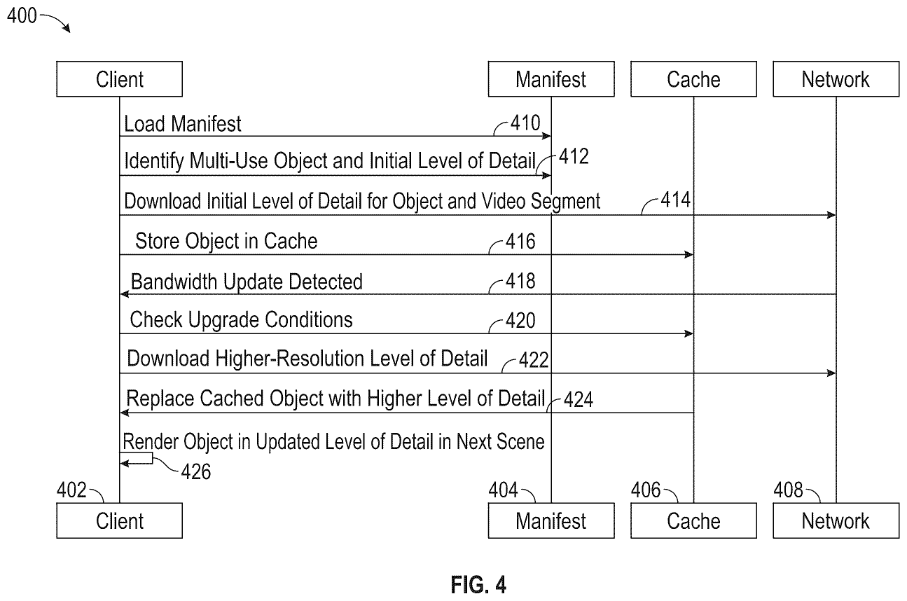

FIG. 4 shows another sequence diagram of illustrative steps for enabling extended reality content delivery, in accordance with some embodiments of the disclosure. Process 400 may be implemented, in whole or in part, on any of the computing devices mentioned herein. In addition, one or more actions of the process 400 may be incorporated into or combined with one or more actions of any other processes, embodiments or examples described herein.

The process 400 comprises a client computing device 402, a manifest 404, a cache 406 of the client computing device 402 and a network 408. In some examples, the manifest 404 is an ABR manifest. At 410, the manifest 404 is received and loaded at the client computing device 402 and, at 412, a multi-use object (of an extended reality scene) is identified along with an initial level of detail. At 414, the selected object is downloaded at the identified level of detail along with a video segment for a content item. At 416, the object is stored in the cache 406 and, at 418, a bandwidth update is detected, for example, due to a change in network conditions. At 420, an upgrade condition (or conditions) is checked, for example if the bandwidth is above a threshold level such as 2000 kbps, and, if the upgrade condition (or conditions) is met, then the object is downloaded at a higher-resolution level of detail. At step 424, the cached object is replaced with the downloaded object at the higher level of detail, and, at step 426, the object is rendered in the updated, higher level of detail in a next scene (i.e., the next extended reality scene).

In an example, the system may enable real-time scene transitions (i.e., of an extended reality experience at an extended reality device) based on, for example, user actions and/or predefined timed events within a received manifest, such as an ABR manifest. This may enable smooth, immediate transitions between scenes in response to user interactions and/or time-based triggers. This may be achieved by pre-loading necessary assets for upcoming scenes based on identified triggers, thereby enabling a client system (e.g., at an extended reality headset) to minimize latency and enabling seamless navigation that maintains user immersion.

The manifest (such as an ABR manifest) may designate specific triggers, such as timecode events; interactive elements; and/or actions (including user actions) that prompt scene (i.e., scenes of an extended reality experience) transitions. When a trigger occurs, the system (e.g., running on an extended reality device) may reference the manifest to identify the next scene and, if conditions permit, pre-load assets, or objects, for that scene in progressively higher levels of detail. This may enhance responsiveness, thereby enabling real-time adjustments to interactions (including user interactions) and/or inputs, and/or enabling improved continuity in storytelling and engagement. A pseudo-HLS manifest as shown below includes event-based triggers for real-time scene transitions. On identifying the event-based triggers in the manifest, the system (e.g., running on the extended reality device) may pre-load assets, or objects, for the next scene based on timecodes and/or identified interactions (including user interactions).

```
{
  “id”: “scene1”,
  “type”: “XR3DScene”,
  “name”: “InteractiveScene”,
  “videoSegments”: [
    {
      “bitrate”: “500kbps”,
      “url”: “https://cdn.example.com/video/scene1_500kbps.mp4”,
      “timecodeStart”: “00:00:00”,
      “timecodeEnd”: “00:05:00”
    },
    {
      “bitrate”: “1500kbps”,
      “url”: “https://cdn.example.com/video/scene1_1500kbps.mp4”,
      “timecodeStart”: “00:00:00”,
      “timecodeEnd”: “00:05:00”
    },
    {
      “bitrate”: “3000kbps”,
      “url”: “https://cdn.example.com/video/scene1_3000kbps.mp4”,
      “timecodeStart”: “00:00:00”,
      “timecodeEnd”: “00:05:00”
    }
  ],
  “levelsOfDetail”: [
    {
      “bitrate”: “500kbps”,
      “url”: “https://cdn.example.com/xr/interactive_lo.glb”,
      “cache”: “no”,
      “use”: “single-use”
    },
    {
      “bitrate”: “1500kbps”,
      “url”: “https://cdn.example.com/xr/interactive_med.glb”,
      “cache”: “no”,
      “use”: “single-use”
    },
    {
      “bitrate”: “3000kbps”,
      “url”: “https://cdn.example.com/xr/interactive_hi.glb”,
      “cache”: “no”,
      “use”: “single-use”
    }
  ],
  “triggerEvents”: [
    {
      “type”: “timecode”,
      “timecode”: “00:04:30”,
      “action”: “load_next_scene”,
      “targetScene”: “scene2”
    },
    {
      “type”: “userAction”,
      “action”: “interactionComplete”,
      “targetScene”: “scene2”,
      “preLoad”: “yes”
    }
  ]
}
```

In the above example pseudo-HLS manifest, the manifest specifies two triggers for scene transitions. These triggers are a timecode trigger at 4 minutes and 30 seconds and a user action trigger, such as completing an interaction within a current scene of an extended reality experience. Upon encountering either trigger, the client (e.g., an extended reality device) may pre-load assets for the next scene (“scene2”) of an extended reality experience. This pre-loading may occur instantly or progressively, based on bandwidth availability to the extended reality device.

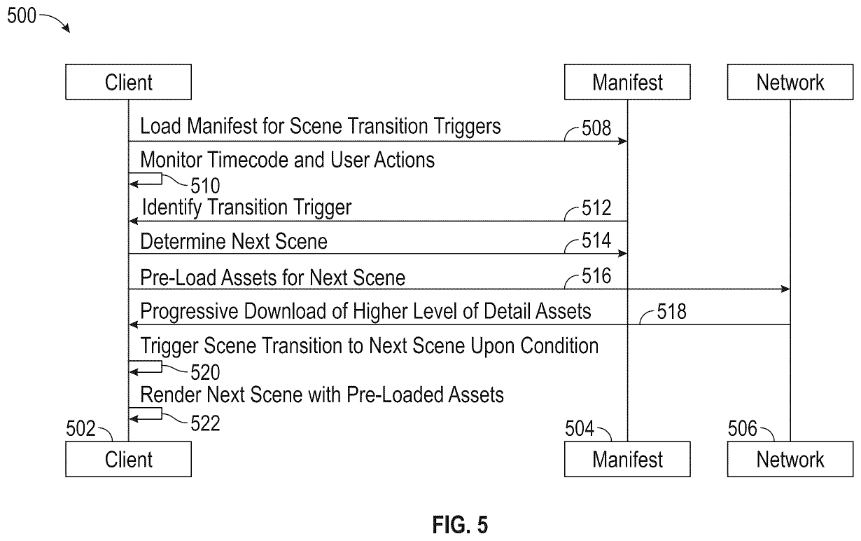

FIG. 5 shows another sequence diagram of illustrative steps for enabling extended reality content delivery, in accordance with some embodiments of the disclosure. Process 500 may be implemented, in whole or in part, on any of the computing devices mentioned herein. In addition, one or more actions of the process 500 may be incorporated into or combined with one or more actions of any other processes, embodiments or examples described herein.

The process 500 comprises a client computing device 502, a manifest 504 and a network 506. In some examples, the manifest 504 is an ABR manifest. At 508, the manifest 504 is received and loaded at the client computing device 502 for scene transition triggers. The scene comprises assets and may be, for example, an extended reality scene. At 510, timecodes and user actions (such as received inputs at the client computing device 502) are monitored. At 512, a transition trigger (such as, for example, a timecode and/or a user action) is identified and, at 514 a next scene is determined. At 516, assets for the next scene are pre-loaded and, at 518, higher level of detail assets of the scene are progressively downloaded, in some examples, as the 506 network bandwidth allows. At 520, a scene transition to the next scene is triggered upon a condition being met, and, at 522, the next scene is rendered with the pre-loaded assets.

In an example, the system (e.g., an extended reality device) may adjust the level of detail of 3D objects of an extended reality scene in a dynamic manner based on, for example, their spatial proximity to a user's viewpoint and/or the object's importance to the media content (e.g., a story line). In some examples, high-fidelity rendering for elements, or objects, that are virtually near the user may be prioritized, and a level of detail of objects that are farther away may be reduced. This proximity-based approach may enable the optimization of resource use by enabling elements of immediate interest to rendered at the highest quality possible, while distant objects utilize a lower level of detail to conserve, for example, bandwidth and processing power at the extended reality device.

When, for example, the client system (i.e., the extended reality device) detects that an object is approaching the user's field of view in an extended reality scene, it requests a higher level of detail version of an object in the scene, progressively upgrading it as it moves closer. Background and/or peripheral elements may remain at lower detail levels until they enter the user's immediate surroundings in the scene. This example may enable dynamic visual adaptation that balances performance with immersion when a user is exploring an extended reality environment.

The following example pseudo-HLS manifest segment defines 3D objects (i.e., of an extended reality scene) with specified levels of detail. This may, for example, enable the system (i.e., the extended reality device) to adjust detail based on proximity to the user in an extended reality scene. Trigger conditions may be set to dynamically increase and/or decrease a level of detail of an object based on distance thresholds, which are defined in the manifest.

```
{
  “id”: “object_nearUser”,
  “type”: “XR3DObject”,
  “name”: “DynamicObject”,
  “levelsOfDetail”: [
    {
      “bitrate”: “500kbps”,
      “url”: “https://cdn.example.com/xr/object_far.glb”,
      “cache”: “yes”,
      “distanceThreshold”: “>20m”
    },
    {
      “bitrate”: “1500kbps”,
      “url”: “https://cdn.example.com/xr/object_medium.glb”,
      “cache”: “yes”,
      “distanceThreshold”: “10m-20m”
    },
    {
      “bitrate”: “3000kbps”,
      “url”: “https://cdn.example.com/xr/object_near.glb”,
      “cache”: “yes”,
      “distanceThreshold”: “<10m”
    }
  ],
  “proximityTriggers”: [
    {
      “condition”: “distance < 10m”,
      “action”: “increaseLevels of detail”,
      “target”: “highest”
    },
    {
      “condition”: “distance > 20m”,
      “action”: “decreaseLevels of detail”,
      “target”:: “lowest”
    }
  ]
}
```

In some examples, a metadata file may indicate shared textures that are shared between objects. In some examples, a quality of texture may be fetched based on how many objects use the texture. In this example, the manifest includes specific levels of detail for an object for each distance threshold associated with the object. In this example, the proximity triggers are set to increase the level of detail of an object as a user virtually moves within 10 meters of the object, switching to the highest available levels of detail when the user is nearby. Conversely, when the user moves farther than 20 meters away from an object in this example, the system (i.e., the extended reality device) switches to the lowest level of detail to, for example, save resources in rendering as well as to preserve consistency in visual appearance due to distances.

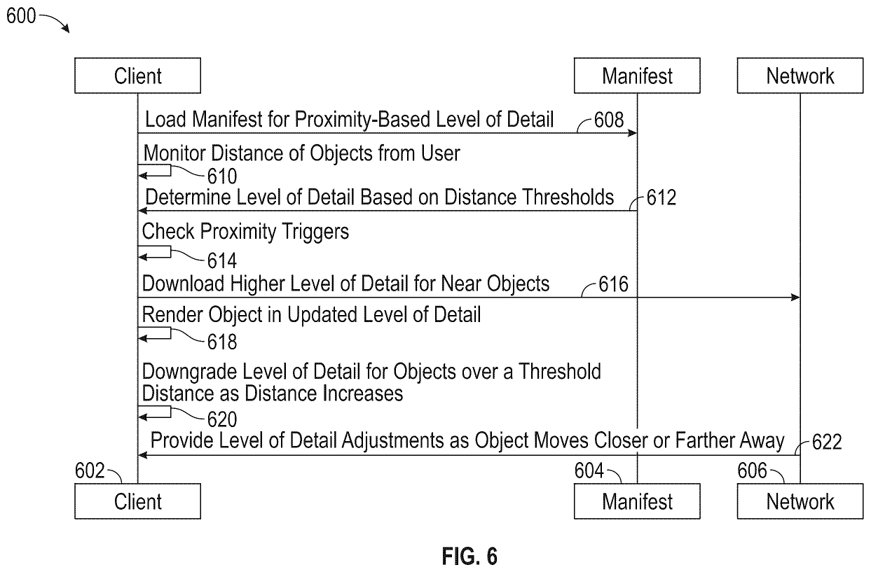

FIG. 6 shows another sequence diagram of illustrative steps for enabling extended reality content delivery, in accordance with some embodiments of the disclosure. Process 600 may be implemented, in whole or in part, on any of the computing devices mentioned herein. In addition, one or more actions of the process 600 may be incorporated into or combined with one or more actions of any other processes, embodiments or examples described herein.

The process 600 comprises a client computing device 602, a manifest 604 and a network 606. In some examples, the manifest 604 is an ABR manifest. At 608, the client computing device 602 receives and loads the manifest 604. In this example, the manifest 604 describes proximity-based levels of detail for objects in a scene, such as an extended reality scene. At 610, the distance of the objects in the scene from a user (i.e., a virtual distance in the extended reality scene between an object and a virtual representation of the user) is monitored, and, at 612, a level of detail of at least a subset of the monitored objects is determined based on one or more distance thresholds. At 614, one or more proximity triggers are checked (for example, whether an object is within a threshold proximity of the virtual representation of the user, such as within 10 meters of the user), and, at 616, a higher level of detail object is downloaded for those objects that are determined to be within a threshold distance, such as within 10 meters, of the virtual representation of the user. At 618, the object is rendered in the updated level of detail. At 620, the level of detail for objects that are over a threshold distance from the user are downgraded as the distance increases and, at 622, level of detail adjustments are provided as a user moves closer or farther away from objects in the extended reality scene. For example, as a virtual representation of the user moves away from an object, the level of detail is downgraded. In an example, a high level of detail may be downloaded and rendered for objects that are within 10 meters, a medium level of detail may be downloaded and rendered for objects that are within 20 meters, but at or further away than 10 meters, and a low level of detail may be downloaded and rendered for objects that are at or farther away than 20 meters.

In an example, a system may enable multiple devices to join a shared viewing session of media content, with one computing device designated as the primary device. This primary device may be, for example, an extended reality device, a smart television, a streaming device and/or a set-top box. In this example, when a shared extended reality session is initiated and/or a device joins the shared extended reality session, the system may designate the first device that connects to the session as the primary device. In this example, the primary device is responsible for downloading a manifest (such as an ABR manifest), managing level of detail adjustments for objects in an extended reality scene and/or pre-fetching 3D assets, or objects, in the extended reality scene. The primary device may, for example, store the fetched objects in a cache at the primary device. In this example, secondary devices, such as additional extended reality devices, then connect to the primary device to retrieve the manifest, receive level of detail updates to objects in the shared extended reality scene and/or fetch 3D assets, or objects. Secondary devices may align their settings with the primary device and other secondary devices to enable a synchronized extended reality experience. This initial exchange may establish a common starting point, enabling all devices to begin with the same playback settings. In this manner, a single device, the primary device, makes all the requests and can transmit the same object to multiple secondary devices. Additionally, redundant requests to a central server delivering content (including the objects) may be minimized thereby conserving bandwidth and enabling synchronized playback across all devices, creating a cohesive shared experience.

During the shared experience, secondary devices rely on the primary device for 3D assets, such as objects of an extended reality scene, and level of detail instructions for those objects. When a secondary device requires a particular 3D asset, or object, it requests it from the primary device, for example, via a local network address of the primary device, rather than contacting a central server to request the objects. For example, if the primary device is an Apple TV, secondary devices may connect to the Apple TV via the Apple TV IP address to access cached 3D assets, or objects. If the requested asset, or object, is already cached on the Apple TV, the Apple TV serves it directly to the secondary device. In some examples, this direct serving of the asset, or object, minimizes latency when compared to receiving the object from a central server. If the asset is not cached, then the primary device may fetch it from the central server, store it locally, for example, in a cache, and then provide it to the requesting secondary device. This setup may enable all devices in a shared extended reality session to have synchronized access to required assets, or objects, while significantly reducing redundant server requests.

In some examples, the primary device continuously monitors available bandwidth (e.g., between the primary device and a central server and/or between the primary device and one or more of the secondary devices). The primary device may adjust level of detail settings for objects of an extended reality scene in real time based on, for example, network conditions. When available bandwidth changes, the primary device may recalculate optimal level of detail settings for shared objects, and the primary device may transmit updated level of detail instructions to all, or a subset, of the secondary devices. This real-time communication may enable all devices to adjust playback quality (e.g., of an extended reality scene) in a coordinated manner, keeping the visual experience consistent across the shared session. If bandwidth conditions degrade, the primary device may instruct secondary devices to switch to fallback level of detail settings, thereby enabling all devices to maintain playback continuity even in low-bandwidth scenarios.

The below example pseudo-HLS manifest demonstrates a setup for a shared viewing session, where the primary device, for example, specified with the IP address of a local Apple TV, manages caching and provides multi-use objects to secondary devices. Secondary devices retrieve the manifest from the primary device and rely on it for real-time level of detail adjustments to objects of an extended reality scene and asset, or object, caching.

```
{
  “id”: “shared_scene”,
  “type”: “XR3DScene”,
  “name”: “CollaborativeViewingScene”,
  “primaryDeviceRole”: “yes”,
  “primary DeviceAddress”: “http://192.168.1.10”,
  “synchronizationSettings”: {
    “sharedObjects”: [
      {
        “id”: “object_shared_001”,
        “name”: “CentralSharedObject”,
        “levelsOfDetail”: [
          {
            “bitrate”: “500kbps”,
            “url”: “https://192.168.1.10/xr/shared_lo.glb”,
            “cache”: “yes”,
            “use”: “multi-use”
          },
          {
            “bitrate”: “1500kbps”,
            “url”: “https://192.168.1.10/xr/shared_med.glb”,
            “cache”: “yes”,
            “use”: “multi-use”
          },
          {
            “bitrate”: “3000kbps”,
            “url”: “https://192.168.1.10/xr/shared_hi.glb”,
            “cache”: “yes”,
            “use”: “multi-use”
          }
        ]
      }
    ],
    “fetchFromPrimary”: “enabled”,
    “updateFrequency”: “real-time”,
    “syncTrigger”: [
      {
        “type”: “bandwidth”,
        “action”: “adjustLevels of detail”,
        “target”: “all_devices”
      }
    ]
  }
}
```

In this example, the primary device is assigned the IP address “192.168.1.10,” which secondary devices use to retrieve shared objects, for example over a local network, and level of detail updates for objects of an extended reality scene. In this example, the manifest enables a “fetchFromPrimary” setting, instructing secondary devices to rely on the primary device, such as an Apple TV, as a local source for asset distribution and level of detail management of extended reality objects. If the primary device detects available bandwidth changes, the primary device may communicate updated level of detail settings to all, or at least a subset of, connected secondary devices, thereby enabling, for example, synchronized adjustments across the session.

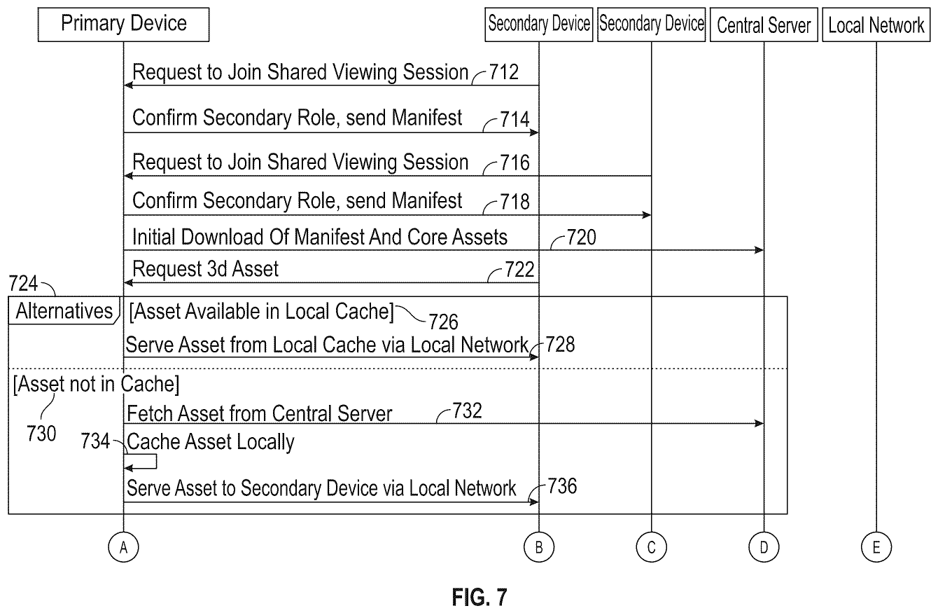

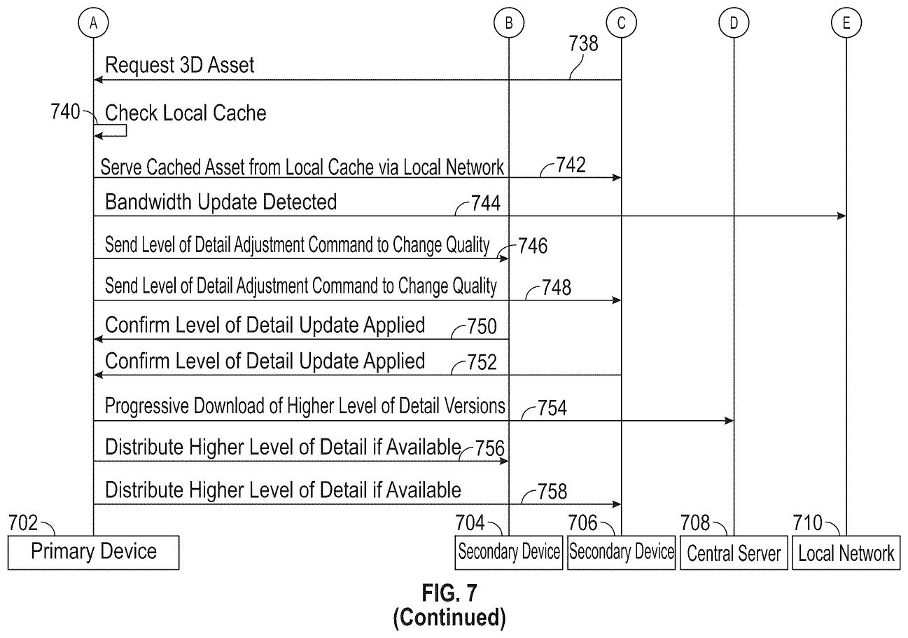

FIG. 7 shows another sequence diagram of illustrative steps for enabling extended reality content delivery, in accordance with some embodiments of the disclosure. Process 700 may be implemented, in whole or in part, on any of the computing devices mentioned herein. In addition, one or more actions of the process 700 may be incorporated into or combined with one or more actions of any other processes, embodiments or examples described herein.

The process 700 comprises a primary computing device 702, a first secondary computing device 704, a second secondary computing device 706, a central server 708 and a local network 710. At 712, a request to join a shared viewing session is received at the primary computing device 702 from the first secondary computing device 704, and, at 714, the primary computing device 702 confirms the secondary role of the first secondary computing device 704 and transmits a manifest to the first secondary computing device 704. At 716, a request to join a shared viewing session is received at the primary computing device 702 from the second secondary computing device 706, and, at 718, the primary computing device 702 confirms the secondary role of the second secondary computing device 706 and transmits a manifest to the second secondary computing device 706. In some examples, at least one of the manifests is an ABR manifest.

At 720, the primary computing device 702 downloads the manifest and core assets for an extended reality scene from a central server 708 and, at 722, the first secondary computing device 704 requests a 3D asset from the primary computing device 702. At 724, the process proceeds to 726 if the requested asset is available in a local cache at the primary computing device 702 or, if the asset is not in a cache at the primary computing device 702, the process proceeds to 730. If the asset is available in the local cache, the process proceeds to 728, where the primary computing device 702 transmits the asset from a local cache via local network 710 to the first secondary computing device 704. If the asset is not in a local cache, the process proceeds to 732, where the asset is fetched from the central server 708 and is transmitted to the primary computing device 702. At 734, the asset is cached locally at the primary computing device 702 and, at 736, the asset is transmitted to the first secondary computing device 704 via the local network 710.

At 738, the second secondary device 706 requests a 3D asset from the primary computing device 702 and, at 740, the primary computing device 702 checks the local cache. In some examples, steps 724-736 may be repeated in a similar manner. In this example, the object is in the local cache at the primary computing device 702 and, at 742, the cached asset is transmitted from the local cache at the primary computing device 702 to the second secondary computing device 706 via the local network 710.

At 744, a change in bandwidth is detected, for example, a reduction in bandwidth. At 746, a level of detail adjustment command to change the quality of an object is transmitted to the first secondary computing device 704, and, at 748, a level of detail adjustment command to change the quality of an object is transmitted to the second secondary computing device 706. In this example, the command is to lower the quality due to the reduction in bandwidth. At 750, the first secondary computing device 704 confirms application of the level of detail update to the object and, at 752, the second secondary computing device 706 confirms application of the level of detail update to the object. At 754, a progressive download of higher level of detail version of the object takes place, for example, as bandwidth improves. At 756, the object is distributed from the primary computing device 702 to the first secondary computing device 704 in a higher level of detail if it becomes available, and, at 758, the object is distributed from the primary computing device 702 to the second secondary computing device 706 in a higher level of detail if it becomes available.

In an example, the system (i.e., an extended reality device) may incorporate individual metadata files for each object or scene, referenced within a main manifest, such as an ABR manifest. These metadata files, structured for example as JSON, may provide detailed instructions for the behavior, orientation and/or spatial placement of 3D objects within an extended reality scene. The metadata for each object may include timecodes that specify when actions such as movement or rotation should occur. This may, for example, ensure that the object behaves appropriately in its context within the extended reality scene.

This approach may enable the efficient reuse of multi-use objects, such as a Greek column, across different extended reality scenes. In addition, this may enable the dynamic adaption of object behavior and/or spatial attributes. For example, in a first scene, the metadata may describe the aforementioned Greek column as standing upright, while in a second scene, the same the aforementioned Greek column may be positioned horizontally, lying on its side. This flexibility may be achieved without needing to download entirely new assets for each context as the system (i.e., the extended reality device) may fetch the corresponding metadata file, which dictates how the object should be rendered and animated in an extended reality scene. Additionally, the size of an object may be set from within the object JSON or metadata file. Below is an example of a pseudo-JSON metadata file for an object, in this case, a Greek column, which includes details on orientation, movement, and timecode-specific actions.

```
{
  “objectId”: “column_01”,
  “name”: “GreekColumn”,
  “actions”: [
    {
      “timecodeStart”: “00:00:00”,
      “timecodeEnd”: “00:05:00”,
      “action”: “move”,
      “direction”: “left_to_right”,
      “speed”: “1.5m/s”
    },
    {
      “timecodeStart”: “00:05:00”,
      “action”: “rotate”,
      “angle”: 90,
      “axis”: “x”
    }
  ],
  “initialOrientation”: {
“position”: { “x”: 0, “y”: 0, “z”: 0 },
“rotation”: { “x”: 0, “y”: 0, “z”: 0 }
  },
  “sceneSpecificAttributes”: {
    “scene1”: {
      “orientation”: {
        “position”: { “x”: 0, “y”: 0, “z” 5 },
        “rotation”: { “x”: 0, “y”: 0, “z” 0 }
      }
    },
    “scene2”: {
      “orientation”: {
        “position”: { “x”: 5, “y”: 0, “z”: 0 },
        “rotation”: { “x”: 90, “y”: 0, “z”: 0 }
      }
    }
  }
}
```

In this example, the metadata for the Greek column, “column_01,” defines actions such as moving from left to right during a specified time window and rotating the column 90 degrees along the x-axis at a certain point. Additionally, the initial orientation of the object and its scene-specific attributes are detailed, enabling the same object to be displayed upright in a first extended reality scene and horizontally in a second extended reality scene without requiring separate 3D models. The manifest may reference this metadata file, providing instructions to the client (i.e., extended reality device) for applying these actions and orientations in, for example, real time based on the current scene and timecode.

In an example, an extended reality user may interact with a content item, such as a movie, on a smart television via, for example, a remote, by providing input for trick-play modes such as fast-forward, rewind, or pause. In this example, the extended reality user, who is immersed in the experience via an extended reality device, may be shown trick mode thumbnails or previews related to the content item being played on the smart television that are seamlessly integrated into the extended reality environment at the extended reality device, without, for example, obstructing the content item being played on the smart television.

When the trick mode functions are initiated at the smart television, the system may dynamically generate thumbnails corresponding to the content item being played at the smart television. These thumbnails may be displayed in a spatial arrangement within the extended reality environment at the extended reality device. Examples of how these thumbnails may be displayed include, for example, at least one of the thumbnails floating to the side and/or above a field of view of the user. This may, for example, ensure that the immersive experience remains uninterrupted. The placement of the thumbnails may be such that blocking of main content in the extended reality scene is avoided.

For example, if a content item is being fast-forwarded at the smart television, the extended reality device may output a series of relatively small and/or semi-transparent thumbnail images aligned along a virtual timeline in a peripheral area of the extended reality scene. These thumbnails may enable the extended reality user to stay aware of the content item progress without interrupting their immersion in an extended reality scene. The thumbnails may also correspond to, for example, timecodes of the fast-forwarded content item, providing context to the content that is being skipped. Once the trick mode operation is complete, the thumbnails may disappear from the extended reality environment, and the extended reality user may return to a fully immersive extended reality experience without obstruction.

This example may be enabled by an ability of the system to monitor trick mode commands from the non-extended reality device, such as a smart television, and generate corresponding extended reality visual cues. These visual cues, for example, in the form of thumbnails, may be displayed contextually within the extended reality environment based on, for example, the position and orientation of a virtual representation of the user in the extended reality environment. This may help to ensure that the visual cues do not interfere with the extended reality experience and/or the content item being played back at the smart television. The following example pseudo-JSON snippet provides an example of how the system may reference trick mode thumbnails within a manifest, such as an ABR manifest, for an extended reality device:

```
{
  “id”: “trick_mode_integration”,
  “type”: “XR3DScene”,
  “name”: “TrickModeThumbnails”,
  “thumbnails”: [
    {
      “timecode”: “00:01:00”,
      “url”: “https://cdn.example.com/thumbnails/thumb_01.png”,
      “position”: { “x”: 1.5, “y”: 0.8, “z”: −2 },
      “size”: { “width”: “0.5m”, “height”: “0.3m” }
    },
    {
      “timecode”: “00:02:00”,
      “url”: “https://cdn.example.com/thumbnails/thumb_02.png”,
      “position”: { “x”: 1.7, “y”: 0.8, “z”: −2 },
      “size”: { “width”: “0.5m”, “height”: “0.3m” }
    }
  ],
  “triggerEvents”: [
    {
      “type”: “fastForward”,
      “action”: “display_thumbnails”,
      “thumbnailsPositioning”: “peripheral”
    },
    {
      “type”: “rewind”,
      “action”: “display_thumbnails”,
      “thumbnailsPositioning”: “peripheral”
    }
  ]
}
```

In this example, manifest describes thumbnails corresponding to specific timecodes in a content item to be placed at defined positions within an extended reality environment. The system may detect trick mode actions such as fast-forward or rewind and triggers the display of thumbnails in the peripheral vision of a user within the extended reality environment. This may ensure that immersive content remains unobstructed in an extended reality environment.

In an example, when a series is being consumed, the system may utilize metadata from upcoming episodes of the series to identify recurring objects in an extended reality scene. If an object is expected to appear in future episodes of the series, it may be retained in a cache at an extended reality device to avoid repeat downloads of the object for each episode in the series. Additionally, in some examples, the system may proactively pre-cache these objects for upcoming episodes based on user viewing habits, for example, stored in a user profile. To support this functionality, the JSON metadata for each episode may include an expiration field for cached assets, specifying how long they should remain in the cache based on anticipated reuse. This may, for example, optimize load times, improve a viewing experience and/or enable efficient cache management across episodes of a series.

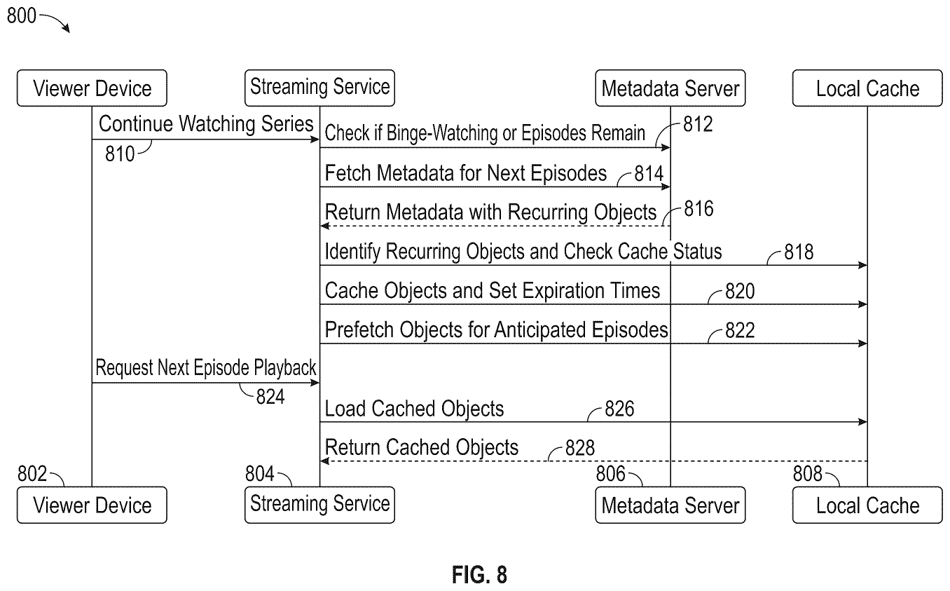

FIG. 8 shows another sequence diagram of illustrative steps for enabling extended reality content delivery, in accordance with some embodiments of the disclosure. Process 800 may be implemented, in whole or in part, on any of the computing devices mentioned herein. In addition, one or more actions of the process 800 may be incorporated into or combined with one or more actions of any other processes, embodiments or examples described herein.

The process 800 comprises a viewer computing device 802, a streaming service 804, a metadata server 806 and a local cache 808 of the viewer computing device 802. At 810, a viewer computing device 802 requests a first episode in a series, and subsequently requests subsequent episodes in the series. At 812, the streaming service 804 checks whether the viewer computing device 802 is in the middle of a binge-watching session or whether episodes remain and, at 814, the streaming service fetches metadata for subsequent episodes in the series. At 816, the metadata server 806 returns metadata with recurring objects in the series to the streaming service 804. At 818, the streaming service identifies recurring objects and checks the local cache 808 status (i.e., whether or not the recuring objects are present in the local cache 808). At 820, the objects are cached in the local cache 808, and an expiration time is set for at least a subset of the cached objects. At 822, one or more objects are prefetched by the streaming service 804 from the local cache 808 for at least one anticipated upcoming episode of the series (for example, when the credits have started for a previous episode and/or an input is received with a “next episode” user interface element). At 824, a request is received at the streaming service 804, from the viewing computing device 802, for a next episode in the series. At 826, at least a subset of the cached objects associated with the upcoming episode are requested by the streaming service 804 from the local cache 808. In some examples, this preloading of the objects associated with the upcoming episode may minimize a load time associated with the objects. At 828, the requested cached objects are transmitted from the local cache 808.

In an example, the system (i.e., an extended reality device) may dynamically pre-fetch fallback versions of essential assets, or objects, of an extended reality scene at lower levels of detail to help enable, for example, smooth playback if an available network bandwidth to the extended reality device reduces. By pre-fetching lower-resolution versions of key assets, or objects, the client (i.e., the extended reality device) may seamlessly (or relatively seamlessly) switch to these fallback assets in the event of a drop in available bandwidth. This may, for example, help to avoid interruptions and/or minimize delays. This example may aid extended reality applications in bandwidth-variable environments, where sudden drops could otherwise cause lag and/or disrupt immersion.

In an example, when the client (i.e., the extended reality device) detects stable bandwidth conditions, the extended reality device may pre-fetch and cache fallback versions of relatively important assets, or objects, of an extended reality scene, such as multi-use objects and/or critical scene components, at a lower level of detail. These assets, or objects, may remain stored locally on the extended reality device, for example in a cache, and may be accessed only in the event that available bandwidth decreases below a threshold amount. In the event that network conditions subsequently improve, the system (i.e., the extended reality device) may resume downloading higher levels of detail for objects in the extended reality scene, progressively upgrading from fallback assets to maintain visual fidelity.

This adaptive pre-fetching and fallback strategy may, for example, reduce dependency on real-time network quality by creating a buffer of essential assets, or objects, of an extended reality scene, thereby helping to enable the extended reality experience to remain smooth even in low-bandwidth scenarios. The following example pseudo-HLS manifest provides fallback settings and instructions to support the pre-fetching of lower-resolution versions of essential assets, or objects, of an extended reality scene, which can be used if bandwidth degrades at the extended reality device.

```
{
  “id”: “adaptive_scene”,
  “type”: “XR3DScene”,
  “name”: “DynamicScene”,
  “levelsOfDetail”: [
    {
      “bitrate”: “3000kbps”,
      “url”: “https://cdn.example.com/xr/scene_hi.glb”,
      “cache”: “yes”,
      “use”: “multi-use”
    },
    {
      “bitrate”: “1500kbps”,
      “url”: “https://cdn.example.com/xr/scene_med.glb”,
      “cache”: “yes”,
      “use”: “multi-use”
    },
    {
      “bitrate”: “500kbps”,
      “url”: “https://cdn.example.com/xr/scene_lo.glb”,
      “cache”: “yes”,
      “use”: “fallback”
    }
  ],
  “fallbackSettings”: {
    “triggerCondition”: “bandwidth < 1000kbps”,
    “fallbackAsset”: “scene_lo.glb”,
    “restoreCondition”: “bandwidth > 1500kbps”
  }
}
```

When utilizing this example manifest, the system (i.e., the extended reality device) may pre-fetch and cache a fallback asset, in this example, “scene_lo.glb” at a lower level of detail, in this example, associated with a bandwidth of 500 kbps, which may be activated if the bandwidth falls below 1000 kbps. In the event that the network bandwidth to the extended reality device exceeds 1500 kbps, then the client (i.e., the extended reality device) may download higher-resolution versions of objects and replace fallback assets, or objects, with standard levels of detail objects as appropriate.

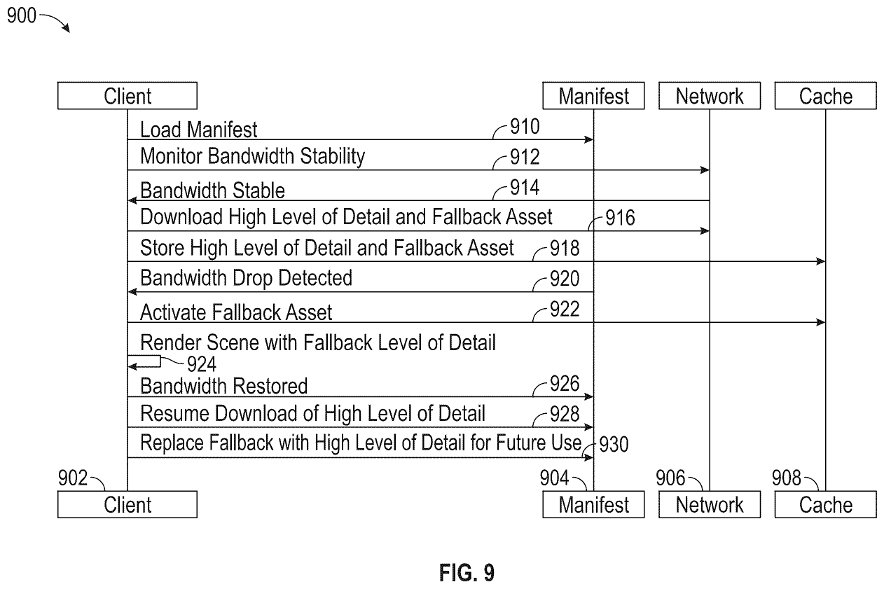

FIG. 9 shows another sequence diagram of illustrative steps for enabling extended reality content delivery, in accordance with some embodiments of the disclosure. Process 900 may be implemented, in whole or in part, on any of the computing devices mentioned herein. In addition, one or more actions of the process 900 may be incorporated into or combined with one or more actions of any other processes, embodiments or examples described herein.

The process 900 comprises a client computing device 902, a manifest 904, a network 906 and a cache 908 of the client computing device 902. In some examples, the manifest 904 is an ABR manifest. At 910, the manifest 940 is loaded at the client computing device 902. In some examples, this loading of the manifest enables pre-fetching and fallback of assets, or objects, in an extended reality scene at the client computing device 902. At 912, the network 906 bandwidth is monitored for stability. At 914, it is detected that the network 906 bandwidth is stable and, at 916, a high level of detail asset and a fallback asset are downloaded to the client computing device 902. At 918, the high level of detail asset and the fallback asset are stored in a cache 908 of the client computing device 902. At 920, a drop in the network 906 bandwidth is detected and, at 922, the fallback asset is activated. At 924, a scene (for example, an extended reality scene) is rendered with the fallback asset. At 926, the network 906 bandwidth is restored and, at 928, asset download at a high level of detail is resumed. At 930, the fallback asset is replaced in the cache 908 with the high level of detail asset for future use.

In an example, the system (i.e., an extended reality device) may handle trick modes, such as rewind, fast-forward and/or pause, by distinguishing between single-use and multi-use assets, or objects, of an extended reality scene. To reduce redundant, or repeat, downloads of objects from a server to the extended reality device and to optimize data usage, the system (i.e., the extended reality device) may prioritize re-downloads of objects for only single-use assets, or objects, while multi-use assets, or objects, may be cached at the extended reality device. This approach may enable bandwidth usage to be minimized and may improve playback speed, enabling single-use assets to be re-fetched only when necessary, while retaining multi-use assets in a local cache for reuse.

In a rewind mode, the system (i.e., the extended reality device) may load lower level of detail versions of single-use assets, or objects, of an extended reality scene to enable previous scenes to be rendered more quickly. Cached multi-use assets, or objects, may be accessed directly from a cache at the extended reality device. This may reduce load times and bandwidth requirements associated with the objects. If the content continues to be rewound, the system (i.e., the extended reality device) may pre-fetch upcoming single-use assets, or objects, at a lower level of detail, thereby creating a buffer to enable, for example, latency to be minimized.

In a fast-forward mode, the client (i.e., the extended reality device) may only download essential keyframes and/or single-use assets, or objects, of an extended reality scene at a reduced level of detail. The extended reality device may render the objects selectively in order to create a summarized version of the content. In some examples, the objects to render may be indicated in a manifest file. In some examples, multi-use assets, or objects, may be reused from a cache of the extended reality device. This may enables critical visuals to be present in the extended reality environment without overloading bandwidth due to the increased display frequency due to the fast-forward mode being initiated. In some examples, non-essential frames may be skipped, allowing navigation through significant content in a more efficient manner.

During a pause mode, the system (i.e., the extended reality device) may prioritize high levels of detail versions of single-use assets, or objects, in an extended reality scene that are within a viewport of the extended reality device. The extended reality device may download the objects progressively while rendering cached multi-use assets from the cache. In this example, background elements, or objects, may be loaded at a deferred rate. This may, for example, enable bandwidth strain to be reduced, thereby enabling users to explore high-detail visuals in the paused scene. In the below example, pseudo-HLS manifest, trick mode settings distinguish between single-use and multi-use assets, defining caching and level of detail preferences for efficient trick mode handling. Level of detail is referred to as LoD in some parts of the example manifest.

```
{
  “id”: “trick mode_scene”,
  “type”: “XR3DScene”,
  “name”: “OptimizedTrickModeScene”,
  “levelsOfDetail”: [
    {
      “bitrate”: “3000kbps”,
      “url”: “https://cdn.example.com/xr/scene_hi.glb”,
      “cache”: “yes”,
      “use”: “multi-use”
    },
    {
      “bitrate”: “1500kbps”,
      “url”: “https://cdn.example.com/xr/scene_med.glb”,
      “cache”: “yes”,
      “use”: “multi-use”
    },
    {
      “bitrate”: “500kbps”,
      “url”: “https://cdn.example.com/xr/scene_lo.glb”,
      “cache”: “yes”,
      “use”: “single-use”
    }
  ],
  “trickModeSettings”: {
    “rewind”: {
      “LoD”: “low”,
      “targetAssets”: “single-use”,
      “preFetchSegments”: “previous”,
      “progressiveUpgrade”: “enabled”
    },
    “fastForward”: {
      “LoD”: “reduced”,
      “targetAssets”: “single-use”,
      “renderKeyframesOnly”: “yes”,
      “backgroundLevels of detail”: “lowest”
    },
    “pause”: {
      “LoD”: “highest”,
      “targetAssets”: “single-use”,
      “focusOn VisibleObjects”: “yes”,
      “backgroundLoad”: “deferred”
    }
  }
}
```

In the above example manifest, single-use assets are specified for re-download during rewind and fast-forward trick-play modes, while multi-use assets are specified as caching at an extended reality device for reuse. In a rewind mode, single-use assets may be loaded at a low level of detail with pre-fetching enabled, which may reduce latency. In a fast-forward mode, the manifest details rendering for keyframes only and lowers the level of detail for background objects, which may conserve bandwidth. In a pause mode, a high level of detail is prioritized for downloading visible single-use assets, or objects, while accessing cached multi-use assets from a cache at the extended reality device.

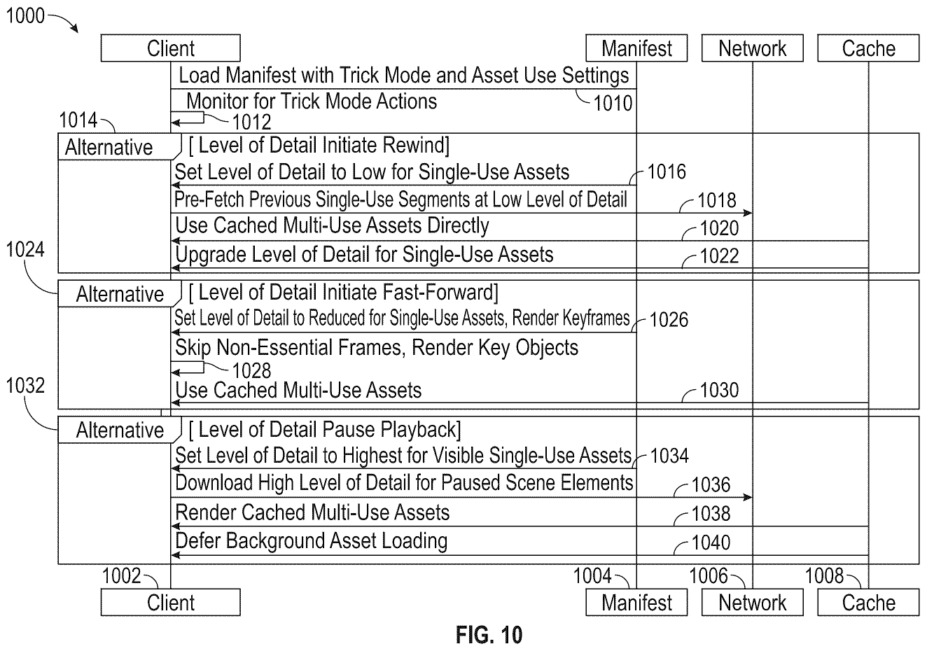

FIG. 10 shows another sequence diagram of illustrative steps for enabling extended reality content delivery, in accordance with some embodiments of the disclosure. Process 1000 may be implemented, in whole or in part, on any of the computing devices mentioned herein. In addition, one or more actions of the process 1000 may be incorporated into or combined with one or more actions of any other processes, embodiments or examples described herein.

The process 1000 comprises a client computing device 1002, a manifest 1004, a network 1006 and a cache 1008 of the client computing device 1002. In some examples, the manifest 1004 is an ABR manifest. At 1010, the client computing device 1002 loads the manifest 1004. In this example, the manifest 1004 indicates trick mode and asset use settings. At 1012, the client computing device 1002 monitors for trick mode actions, such as receiving an input associated with activating a trick mode. Example trick modes include rewind, fast-forward and/or pause.

If, at 1012, a rewind trick mode is initiated, then the process proceeds to 1014 where, at 1016, a low level of detail is set for single-use assets (for example, of an extended reality scene) and, at 1018, previous single-use segments are pre-fetched at a low level of detail. At 1020, cached multi-use assets are used directly from the cache 1008, and, at 1022, the level of detail is upgraded for single-use assets. In some examples, step 1022 may only be performed if network 1006 bandwidth allows.

If, at 1012, a fast-forward trick mode is initiated, then the process proceeds to 1024 where, at 1026, a level of detail for single-use assets (for example, in an extended reality scene) is set to reduced, and key frames (for example in a content item) are rendered at the client computing device 1002. At 1028, non-key frames are skipped and only essential objects are rendered. At 1030, multi-use assets are retrieved from the cache 1008, for example, for efficiency.

If, at 1012, a pause trick mode is initiated, then the process proceeds to 1032 where, at 1034, a level of detail is set to a highest level for visible single-use assets. At 1036, high level of detail assets are downloaded for paused scene elements and, at 1038 cached multi-use assets are rendered. At 1040, background asset loading is deferred.

In an example, a system may optimize the delivery of 3D objects, of an extended reality scene, that share common components, such as textures and materials, by creating a map of these shared components across all 3D objects within the extended reality experience. This map may enable the generation of alternate versions of each 3D object, while omitting common components where possible to, for example, reduce download size. A delivery-side service may determine which version of each 3D object to deliver to the client (i.e., an extended reality device) based on download sequencing rules outlined in previous example, enabling shared components to be delivered only once.

As the delivery-side service establishes the download sequence for 3D objects, the first object containing a shared component in the order may be the original version, including the complete set of shared components. All subsequent objects that reference the same shared component may be delivered in a modified version with that component removed. For each 3D object that has had a shared component removed, the service may append metadata to the object, tagging it with an identifier for the shared component, the name of the original 3D object that contains it and/or a fallback link to the full version of the object. This setup enables an extended reality device to retrieve the full version of the 3D object with all components intact in the event of an error preventing the client from accessing the shared component from the original source object. Additionally, for the 3D object containing the shared component, metadata may include a list of dependent objects requiring that component, as well as details on the component name, memory location and/or size.

Upon receiving a 3D object with omitted components, the client (i.e., the extended reality device) may use an accompanying metadata tag to locate previously downloaded objects containing the removed components. Depending on the client (i.e., extended reality device) rendering system and/or storage configuration, the client may either copy the missing components into the new 3D object for completion or create a memory link referencing the component location in the previously downloaded object. This flexibility may enable the client (i.e., extended reality device) to optimize either for storage or processing efficiency, depending on the system (i.e., extended reality device) capabilities and requirements.

Further, the client (i.e., extended reality device) may maintain a persistent map of stored shared components on the extended reality device, enabling future extended reality experiences using the same client application to reference and reuse these components. As new extended reality experiences are downloaded, this map may be updated by adding and/or removing references to shared components and/or their parent objects

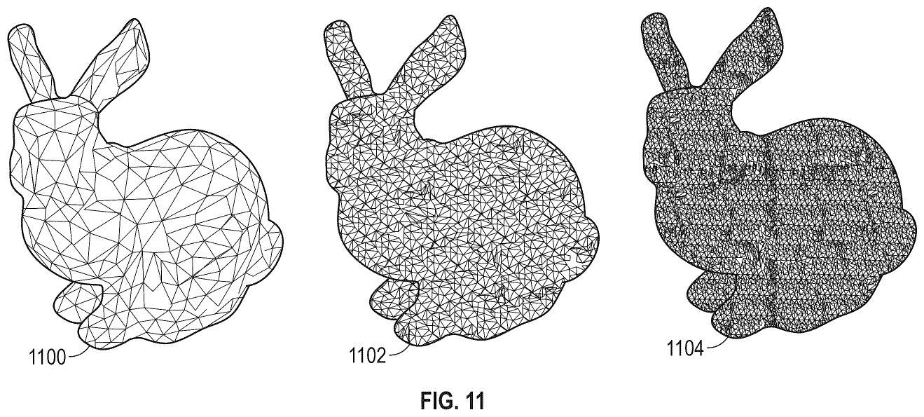

FIG. 11 shows a schematic diagram of different detail levels of an object of an extended reality scene, in accordance with some embodiments of the disclosure. In this example, the same object is rendered with different numbers of polygons. FIG. 11 shows an example of three levels (relatively low, mid and high) of detail and quality of a same object of an extended reality scene. The different details of the object may be formed as different layers of the object. The first rendering 1100 comprises a relatively small number of relatively large polygons, and hence the object is rendered at a relatively low detail level. The second rendering 1102 comprises a relatively middling number of polygons of a middle size, and hence the object is rendered at a relatively middling detail level. The third rendering 1104 comprises a relatively large number of polygons of a relatively small size, and hence the object is rendered at a relatively high detail level.

The delivery of different quality levels may be flexible if the asset is encoded in a scalable manner. A single stream may offer a base layer of the object and one or more enhancement layers of the object. This may enable an ordered, seamless progression of quality levels of the object. The varying quality levels may independently come from the delivery and presentation, which do not have to be symmetric as in the traditional ABR video streaming, even in the case of scalable coding (e.g., scalable video coding (SVC) or scalable high efficiency video coding (SHVC)). Depending on the quality requirement at different times of rendering or re-rendering, one or more enhancement layers may not get decoded and presented even if they are delivered.

A 3D object of an extended reality scene may be delivered at a requested quality level to an extended reality device, assuming that bandwidth permits; however, rendering and/or presentation of the object may use all, or a subset of, layers in a delivered stream. This may enable asymmetric rendering from delivery. This may optimize the user experience when it is desired to match the quality level with the primary media (i.e., a content item being viewed on a smart television) and/or the quality level of other 3D objects that are rendered and presented at the same time.

A 3D object may be requested at an extended reality device for progressive update of quality if one or more enhancement layers are not yet delivered; however, this request of progression may be subject to an optimization or prioritization that considers the quality of primary media (i.e., a content item being output at an associated smart television) and/or other 3D objects at the extended reality device. For example, an enhancement layer for the highest quality of an object may never be requested in a session if the general quality of the experience (i.e., that of a content item being output at an associated smart television and/or other objects of an extended reality scene) remains at a relatively middling level. In some examples, a certain quality level of rendering 3D objects may work with a range of quality and bitrate levels in the general ABR streaming of the primary media (e.g., a content item being output at a smart television).

For an irreplaceable object in an extended reality scene, caching may be prioritized, after delivery and first presentation of the object. This may be, for example, in anticipation of re-rendering of the object at a later instance due to, for example, an interaction with the object or the user rewinds to the scene again.

For a replaceable object in an extended reality scene, if the object is not delivered in time for high-quality rendering, an alternate object available at the expected, or higher, quality level may be used for presentation in an extended reality scene. For an alternate object available at a higher quality level, the rendering of the object may be limited to the expected level, for example, by excluding unnecessary enhancement layers in the decoding and presentation of the object.

In some examples, an object of an extended reality scene may be replaced with one or more alternate objects. In this example, there may be an optimization and/or prioritization to avoid using a same alternate object too often and/or too many alternative objects at the same time. This optimization may take into account quality expectations and/or rendering complexities.

In some examples, upgrading a replaceable object of an extended reality scene may be given a lower priority than upgrading an irreplaceable object in the extended reality scene in an optimization that takes into account available bandwidth, quality and/or complexity of an extended reality scene. The storage and rendering of content, such as objects of an extended reality scene, compressed in scalable solutions may occur in the cloud (e.g., servers remote from the smart television and/or extended reality device), edge and/or client devices (such as an extended reality device).

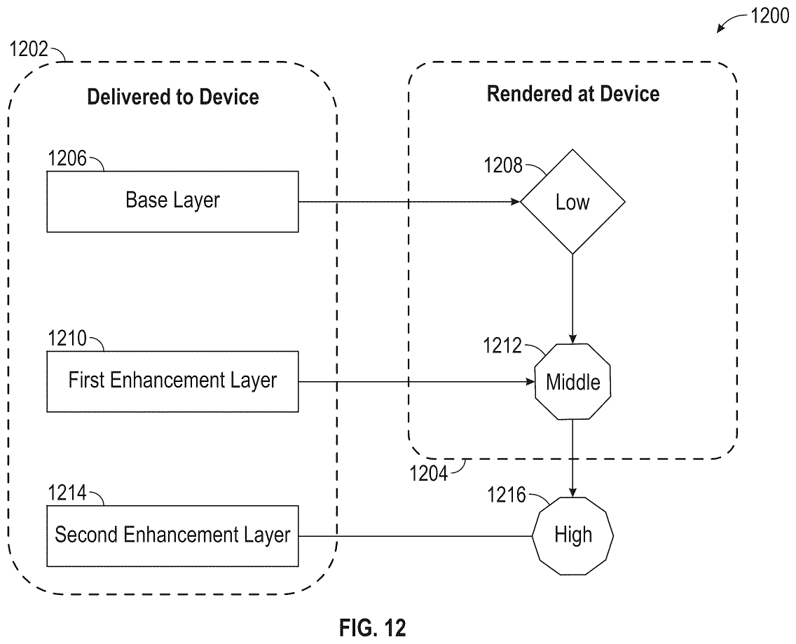

FIG. 12 shows another sequence diagram of illustrative steps for enabling extended reality content delivery, in accordance with some embodiments of the disclosure. Process 1200 may be implemented, in whole or in part, on any of the computing devices mentioned herein. In addition, one or more actions of the process 1200 may be incorporated into or combined with one or more actions of any other processes, embodiments or examples described herein. In particular, FIG. 12 illustrates an example where a high quality is delivered for an object of an extended reality scene; however, the rendering and/or presentation of the object may remain at a middle level. The rendering and/or presentation of the object may remain at the middle level to, for example, match the quality of primary media (such as a content item being played at an associated smart television) and/or other 3D objects of the extended reality scene. In some examples, the object may be presented in place of another object that was only available at a low quality at the time of presentation when, for example, a middle quality is desired.

The process 1200 comprises layers that are transmitted 1202 to a client computing device and steps that are rendered 1204 at the client computing device. At 1206, a base layer is transmitted to the client computing device and the object is rendered at a relatively low 1208 detail level. At 1210, a first enhancement layer is transmitted to the client computing device, and the object is rendered at a relatively middle 1212 detail level. At 1214, a second enhancement layer is transmitted to the client computing device, and the object is rendered at a relatively high 1216 detail level.

In some examples, a high-quality rendering of the object may be triggered at another time instance where other objects in an extended reality scene may be presented in high quality. For example, the object may appear again in a later scene of high quality in primary media content, such as a content item being output at an associated smart television, as the available bandwidth has improved since a first presentation of the object.

In the case of mesh representation of an object, the compression of geometry and texture of the object may be performed by different scalable codecs. For example, different resolutions of vertices and triangulations may be retained through abstraction. Meanwhile, the texture and color data for an object may be, for example, subject to a scalable image and/or video codec that offers progressive decoding and presentation. Multiplexing the geometry and texture of an object from coarse to fine levels may be designed and optimized to create various combinations of levels in quality, complexity and/or data size of the object.

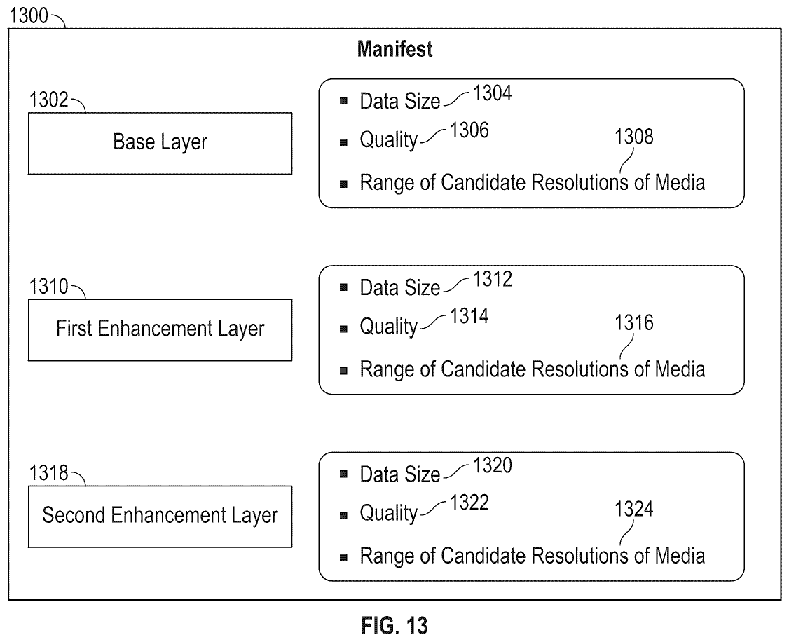

FIG. 13 shows a schematic manifest for enabling extended reality content delivery, in accordance with some embodiments of the disclosure. In particular, FIG. 13 presents an example manifest that comprises the multiple layers of data for an object of an extended reality scene. The syntax and semantics of signaling or fields associated with each layer may vary, depending on the design and implementation.

The manifest 1300 describes, for a base layer 1302, a first enhancement layer 1310 and a second enhancement layer 1318, respectively, data size fields 1304, 1312, 1320; layer quality fields 1306, 1314, 1322; and a range of candidate resolutions for the media fields 1308, 1316, 1324. In some examples, the base layer 1302 may have a range of candidate resolutions of the primary media of up to 480p, i.e., the base layer may work well and visually consistently when the primary media is up to 480p, the first enhancement layer 1310 may have a range of candidate resolutions of 480p to 1080p and the second enhancement layer 1318 may have a range of candidate resolutions of 1080p and greater.

The data size field 1304, 1312, 1320 may specify the amount of data for each layer and/or the accumulated amount of data comprising the lower layers as well. The quality field 1306, 1314, 1322 may designate the expected quality level when the current layer is delivered and/or rendered along with its lower layers. Additional syntax, for example, complexity field, may be included in the manifest 1300 if, for example, more features and flexibility are desired for the purposes of estimation.

The data size field 1304, 1312, 1320, or accumulated data size, corresponding to a certain layer, or a combination of layers, may be used to calculate an estimate of bandwidth and/or bitrate required to deliver the asset, or object, of an extended reality scene in an expected quality in time for rendering and presentation. Under a bandwidth constraint when delivering an aggregate of primary media content, such as a content item being delivered to an associated smart television, and different 3D assets, or objects, optimization and prioritization may be applied to ensure an optimal quality of experience, for example, in a best effort manner. Progressive upgrades may therefore be achieved by starting a delivery of an object layer at a low quality and later streaming one or more object enhancement layers to improve the quality over time, which may be useful, for example, if the available bandwidth for delivering the layers is constrained.

An example use of the range of candidate resolutions of media field 1308, 1316, 1324 may be that of creating a coherent, consistent extended reality experience when combining and/or compositing various types of content, or objects of the extended reality scene. The quality of primary media, such as a content item being streamed to an associated smart television, may be considered when rendering the associated 3D assets, or objects, in a specified extended reality scene at an extended reality device. The range of candidate resolution of media field 1308, 1316, 1324 may be subject to adjustment in the content creation process, where creative choices are made to enable an intended visual presentation of an extended reality scene at an extended reality device. In some examples, preferences and/or settings, for example, stored in a user profile, may be taken into account in final rendering choices of the layers of an object.

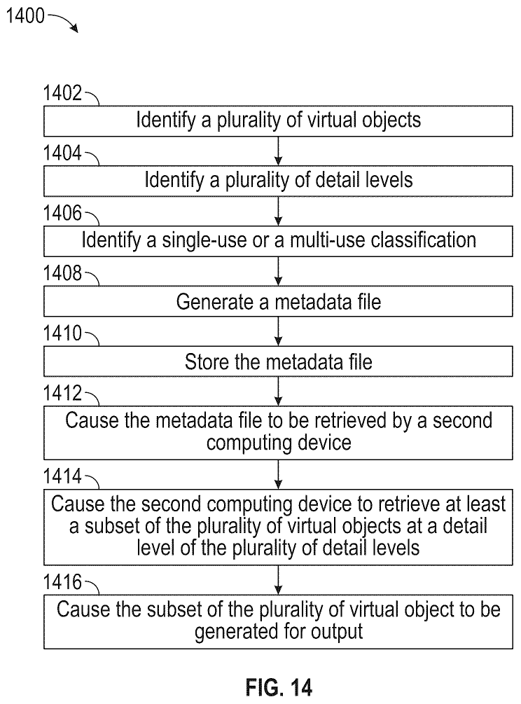

FIG. 14 shows a flowchart of illustrative steps for enabling extended reality content delivery, in accordance with some embodiments of the disclosure. Process 1400 may be implemented, in whole or in part, on any of the computing devices mentioned herein. In addition, one or more actions of the process 1400 may be incorporated into or combined with one or more actions of any other processes, embodiments or examples described herein.

At 1402, a plurality of virtual objects (for example, of an extended reality scene) is identified and, at 1404, a plurality of detail levels for each of at least a subset of the plurality of virtual objects is identified. At 1406, a single-use or a multi-use classification is identified for at least a subset of virtual objects and, at 1408, a metadata file is generated for the plurality of virtual objects. The metadata file indicates, for example, for each object of the plurality of virtual objects, the plurality of detail levels, a location of the object for each detail level of the plurality of detail levels and the single-use or the multi-use classification. At 1410, the metadata file is stored, and, at 1412, the metadata file is caused to be retrieved by a second computing device. At 1414, the second computing device is caused to retrieve at least a subset of the plurality of virtual objects at a detail level of the plurality of detail levels, and, at 1416, the subset of the plurality of virtual objects is caused to be generated for output.

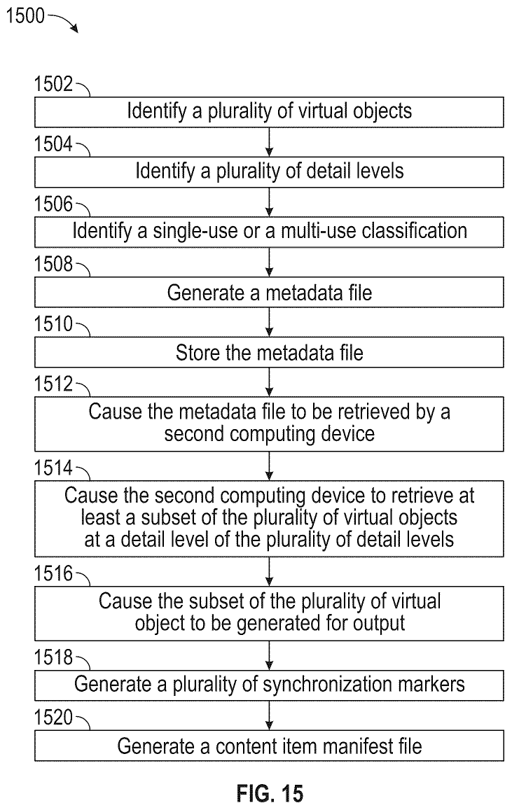

FIG. 15 shows another flowchart of illustrative steps for enabling extended reality content delivery, in accordance with some embodiments of the disclosure. Process 1500 may be implemented, in whole or in part, on any of the computing devices mentioned herein. In addition, one or more actions of the process 1500 may be incorporated into or combined with one or more actions of any other processes, embodiments or examples described herein.

At 1502, a plurality of virtual objects (for example, of an extended reality scene) is identified, and, at 1504, a plurality of detail levels for each of at least a subset of the plurality of virtual objects is identified. At 1506, a single-use or a multi-use classification is identified for at least a subset of virtual objects, and, at 1508, a metadata file is generated for the plurality of virtual objects. The metadata file indicates, for example, for each object of the plurality of virtual objects, the plurality of detail levels, a location of the object for each detail level of the plurality of detail levels and the single-use or the multi-use classification. At 1510, the metadata file is stored, and, at 1512, the metadata file is caused to be retrieved by a second computing device. At 1514, the second computing device is caused to retrieve at least a subset of the plurality of virtual objects at a detail level of the plurality of detail levels, and, at 1516, the subset of the plurality of virtual objects is caused to be generated for output. At 1518, a plurality of synchronization markers is generated for synchronizing output of at least a subset of the plurality of objects with a content item. At 1520, a content item manifest file is generated, wherein the content item manifest file comprises, for example, a plurality of quality levels for each segment of the plurality of segments, a second location of each segment of the plurality of segments for each detail level of the second plurality of detail levels, and an indication of the plurality of synchronization markers.

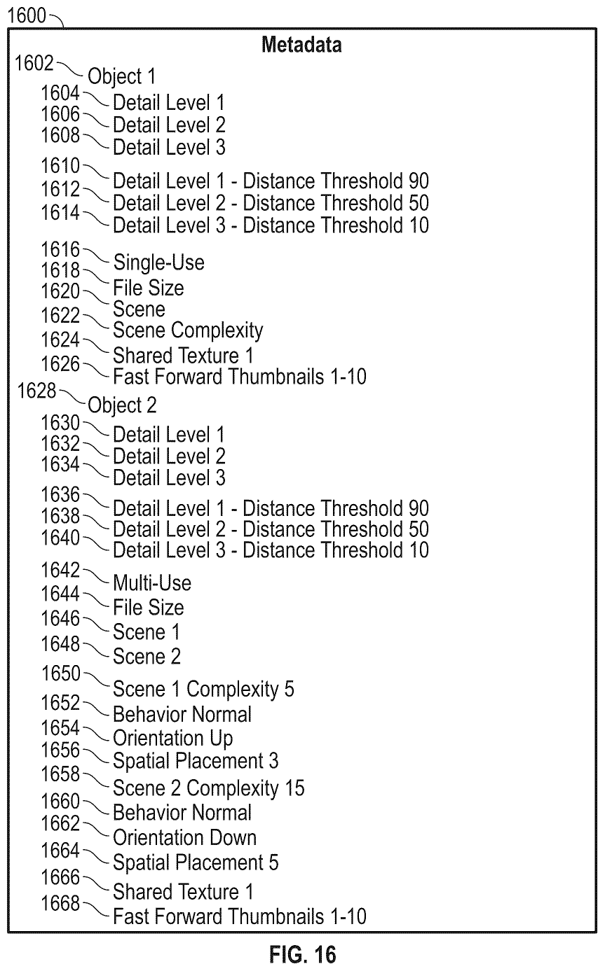

FIG. 16 shows an example metadata file, in accordance with some embodiments of the disclosure. The metadata file describes attributes that may apply to a first object, “Object 1” 1602 and a second object, “Object 2” 1628. The objects 1602, 1628 may be objects from, for example, an extended reality scene. The attributes may be detailed in different fields in the metadata. In this example, Object 1 1602 has first, second and third detail levels 1604, 1606, 1608 associated with it. In some examples, these detail levels may comprise an associated URL indicating where Object 1 1602 may be downloaded from at each detail level 1604, 1606, 1608. In this example, each detail level also has a distance threshold 1610, 1612, 1614 associated with it. The distance threshold may comprise a numerical value indicating a virtual distance from a user at which each detail level applies. For example, as a user is closer to an object in an extended reality scene, a higher detail level may be indicated. A classification 1616 of Object 1 is also indicated, in this example, single-use. In some examples, the object may be single-use or multi-use, in which case a classification field may have a simple “1” or “0” indicating, for example, single-use or multi-use. A file size 1618 of Object 1 may be indicated in a file size field. This may indicate a file size in, for example, bytes, of Object 1 at the different detail levels. A scene 1620 of the extended reality scene in which Object 1 1602 appears may also be indicated in a scene field. Scenes may have unique identifiers and/or names, which are indicated in this field. A scene complexity 1622 field may be utilized to indicate how complex a scene is. The complexity may be based on, for example, a number of objects in a scene and/or a degree of movement associated with the objects in a scene. The complexity field may have a numerical value associated with it, for example, 1 being indicative of a low complexity and 10 being indicative of a high complexity. In another example, the complexity may be indicated as high or low. The metadata file may also comprise a shared texture 1624 field. The shared texture field may be utilized to indicate whether a texture is shared between objects. This field may refer to objects with a unique identifier. A fast-forward thumbnails 1626 field may be utilized to indicate thumbnails to be displayed when a fast-forward input is received.

Object 2 1628 also has first, second and third detail levels 1630, 1632, 1634 associated with it. In some examples, these detail levels may comprise an associated URL indicating where Object 2 1628 may be downloaded from at each detail level 1630, 1632, 1634. In this example, each detail level also has a distance threshold 1636, 1638, 1640 associated with it. A classification 1642 of Object 1 is also indicated, in this example, multi-use. A file size 1644 of Object 1 may be indicated in a file size field. Scenes 1646, 1648 of the extended reality scene in which Object 2 1628 appears may also be indicated in the scene fields. Scene complexity 1650, 1658 fields may be utilized to indicate how complex a scene is. In addition, fields indicating object behavior 1652, 1660, object orientation 1654, 1662 and object spatial placement 1656, 1664 may also be utilized for each scene. The metadata file may also comprise a shared texture 1666 field. A fast-forward thumbnails 1668 field may be utilized to indicate thumbnails to be displayed when a fast-forward input is received.

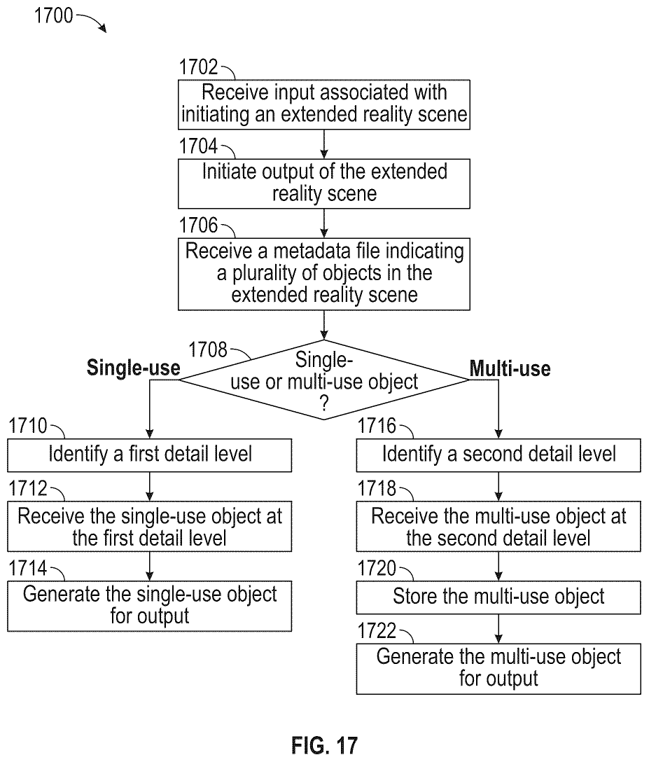

FIG. 17 shows another flowchart of illustrative steps for enabling extended reality content delivery, in accordance with some embodiments of the disclosure. Process 1700 may be implemented, in whole or in part, on any of the computing devices mentioned herein. In addition, one or more actions of the process 1700 may be incorporated into or combined with one or more actions of any other processes, embodiments or examples described herein.

At 1702, an input associated with initiating an extended reality scene is received at a computing device, and, at 1704, an output of the extended reality scene is initiated. At 1706, a metadata file indicating a plurality of objects in the extended reality scene is received. The metadata file indicates, for each object of a plurality of objects in the extended reality scene, a plurality of detail levels and a single-use classification or a multi-use classification. At 1708, it is determined whether the object is a single-use object or a multi-use object, for example, based on data in the received metadata file.

If, at 1708, it is determined that the object is a single-use object, then the process proceeds to 1710, where a first detail level is identified. At 1712, the single-use object is received at the first detail level, and, at 1714, the single-use object is generated for output.

If, at 1708, it is determined that the object is a multi-use object, then the process proceeds to 1716, where a second detail level is identified. At 1718, the multi-use object is received at the second detail level, and, at 1720, the multi-use object is stored, for example at a cache of a computing device. At 1722, the multi-use object is generated for output, for example, after being retrieved from the cache.

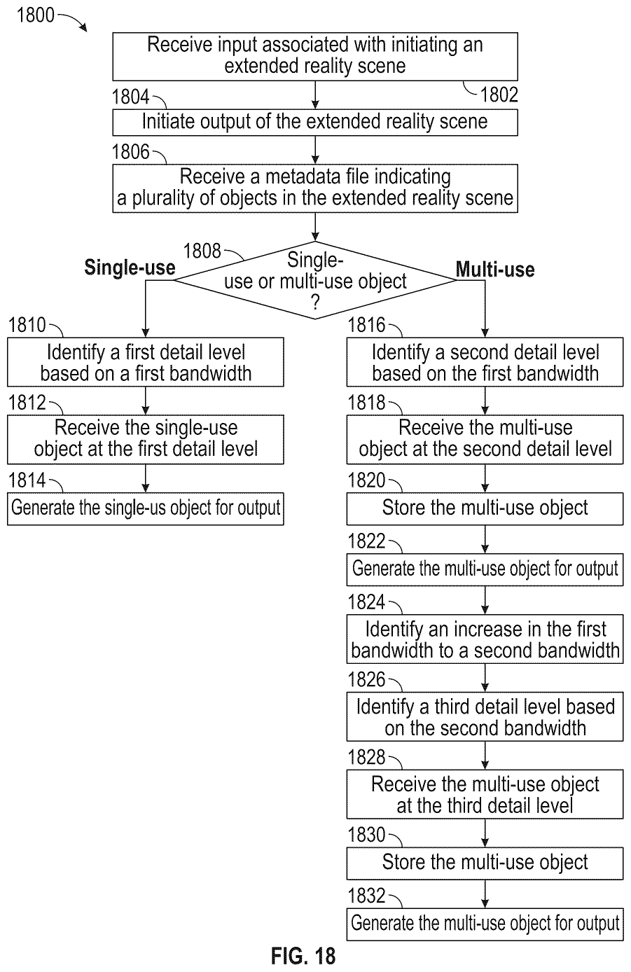

FIG. 18 shows another flowchart of illustrative steps for enabling extended reality content delivery, in accordance with some embodiments of the disclosure. Process 1800 may be implemented, in whole or in part, on any of the computing devices mentioned herein. In addition, one or more actions of the process 1800 may be incorporated into or combined with one or more actions of any other processes, embodiments or examples described herein.

At 1802, an input associated with initiating an extended reality scene is received at a computing device, and, at 1804, an output of the extended reality scene is initiated. At 1806, a metadata file indicating a plurality of objects in the extended reality scene is received. The metadata file indicates, for each object of a plurality of objects in the extended reality scene, a plurality of detail levels and a single-use classification or a multi-use classification. At 1808, it is determined whether the object is a single-use object or a multi-use object, for example, based on data in the received metadata file.

If, at 1808, it is determined that the object is a single-use object, then the process proceeds to 1810, where a first detail level is identified based on a first bandwidth, for example, a bandwidth of a network connection utilized by the computing device. At 1812, the single-use object is received at the first detail level and, at 1814, the single-use object is generated for output.

If, at 1808, it is determined that the object is a multi-use object, then the process proceeds to 1816, where a second detail level is identified based on the first bandwidth. At 1818, the multi-use object is received at the second detail level, and, at 1820, the multi-use object is stored, for example, at a cache of a computing device. At 1822, the multi-use object is generated for output, for example, after being retrieved from the cache. At 1824, an increase in the first bandwidth to a second bandwidth is identified, for example, due to a change in network conditions. At 1826, a third detail level is identified based on the second bandwidth, for example, a higher detail level due to more bandwidth being available. In some examples, a bandwidth decrease may be identified at step 1824, and a lower detail level may be identified at step 1826. At 1828, the multi-use object is received at the second detail level, and, at 1830, the multi-use object is stored, for example, at the cache of a computing device. At 1832, the multi-use object is generated for output, for example, after being retrieved from the cache.

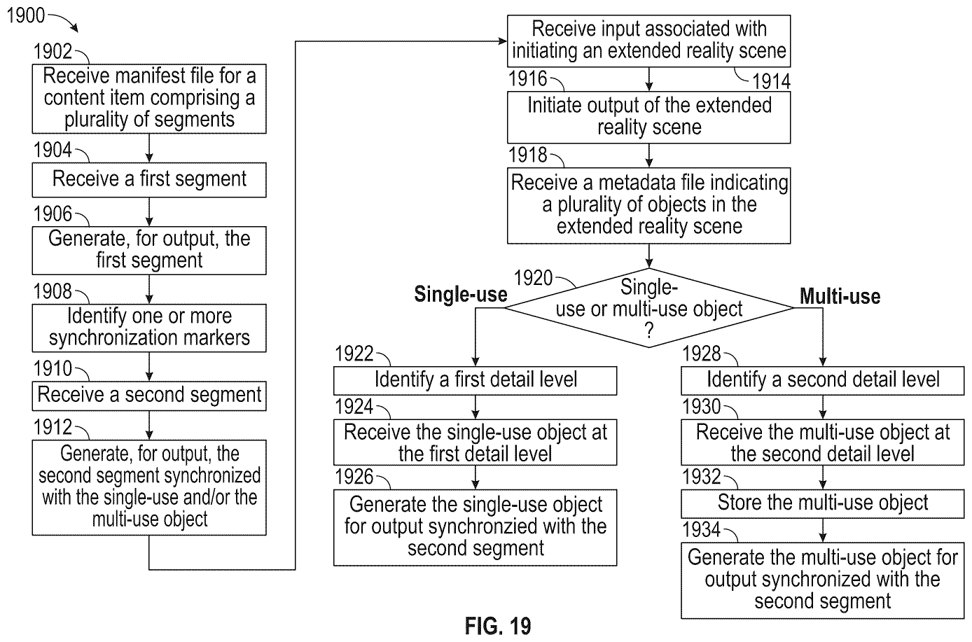

FIG. 19 shows another flowchart of illustrative steps for enabling extended reality content delivery, in accordance with some embodiments of the disclosure. Process 1900 may be implemented, in whole or in part, on any of the computing devices mentioned herein. In addition, one or more actions of the process 1900 may be incorporated into or combined with one or more actions of any other processes, embodiments or examples described herein.

At 1902, a manifest file for a content item comprising a plurality of segments is received at a computing device. The manifest file may be an ABR manifest file. At 1904, a first segment of the content item is received, and, at 1906, the first segment is generated for output. At 1908, one or more synchronization markers are identified. At 1910, a second segment of the content item is received, and, at 1912, the second segment is generated for output synchronized with a single-use and/or a multi-use object of an extended reality scene, as detailed below.

At 1914, an input associated with initiating an extended reality scene is received at a computing device, and, at 1916, an output of the extended reality scene is initiated. At 1918, a metadata file indicating a plurality of objects in the extended reality scene is received. The metadata file indicates, for each object of a plurality of objects in the extended reality scene, a plurality of detail levels and a single-use classification or a multi-use classification. At 1920, it is determined whether the object is a single-use object or a multi-use object, for example, based on data in the received metadata file.

If, at 1920, it is determined that the object is a single-use object, then the process proceeds to 1922, where a first detail level is identified. At 1924, the single-use object is received at the first detail level, and, at 1926, the single-use object is generated for output, synchronized with the second segment and based on the synchronization markers.

If, at 1920, it is determined that the object is a multi-use object, then the process proceeds to 1928, where a second detail level is identified. At 1930, the multi-use object is received at the second detail level, and, at 1932, the multi-use object is stored, for example at a cache of a computing device. At 1934, the multi-use object is generated for output, synchronized with the second segment and based on the synchronization markers, for example, after being retrieved from the cache.

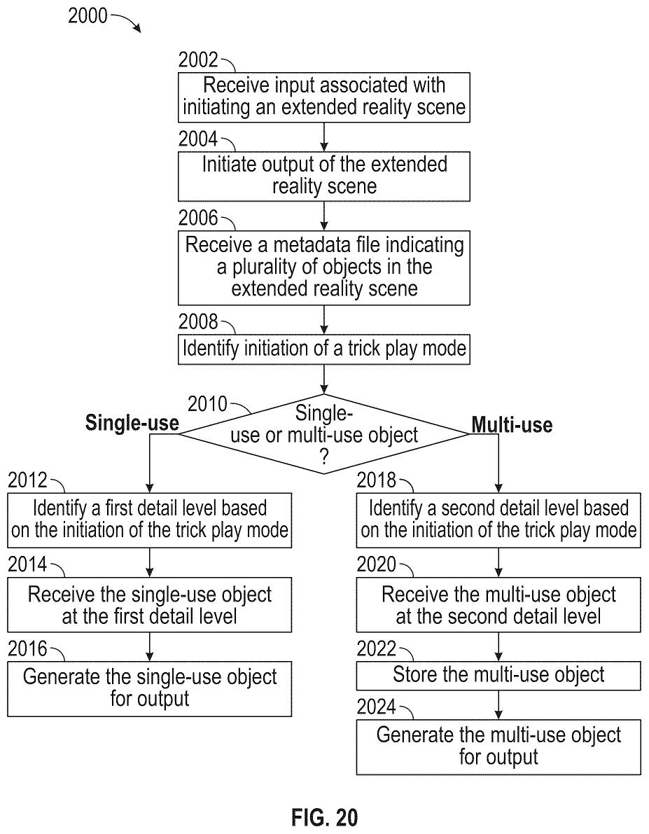

FIG. 20 shows another flowchart of illustrative steps for enabling extended reality content delivery, in accordance with some embodiments of the disclosure. Process 2000 may be implemented, in whole or in part, on any of the computing devices mentioned herein. In addition, one or more actions of the process 2000 may be incorporated into or combined with one or more actions of any other processes, embodiments or examples described herein.

At 2002, an input associated with initiating an extended reality scene is received at a computing device, and, at 2004, an output of the extended reality scene is initiated. At 2006, a metadata file indicating a plurality of objects in the extended reality scene is received. The metadata file indicates, for each object of a plurality of objects in the extended reality scene, a plurality of detail levels and a single-use classification or a multi-use classification. At 2008, the initiation of a trick-play mode is identified. For example, it is identified whether an input associated with a fast-forward, rewind and/or pause command is received at the computing device. At 2010, it is determined whether the object is a single-use object or a multi-use object, for example, based on data in the received metadata file.

If, at 2010, it is determined that the object is a single-use object, then the process proceeds to 2012, where a first detail level is identified based on the initiation of the trick-play mode. For example, a relatively low level of detail may be identified based on a fast-forward or rewind command, and a relatively high level of detail may be identified based on a pause command. At 2014, the single-use object is received at the first detail level, and, at 2016, the single-use object is generated for output.

If, at 2010, it is determined that the object is a multi-use object, then the process proceeds to 2018, where a second detail level is identified based on the initiation of the trick-play mode. For example, a relatively low level of detail may be identified based on a fast-forward or rewind command, and a relatively high level of detail may be identified based on a pause command. At 2020, the multi-use object is received at the second detail level, and, at 2022, the multi-use object is stored, for example, at a cache of a computing device. At 2024, the multi-use object is generated for output, for example, after being retrieved from the cache.

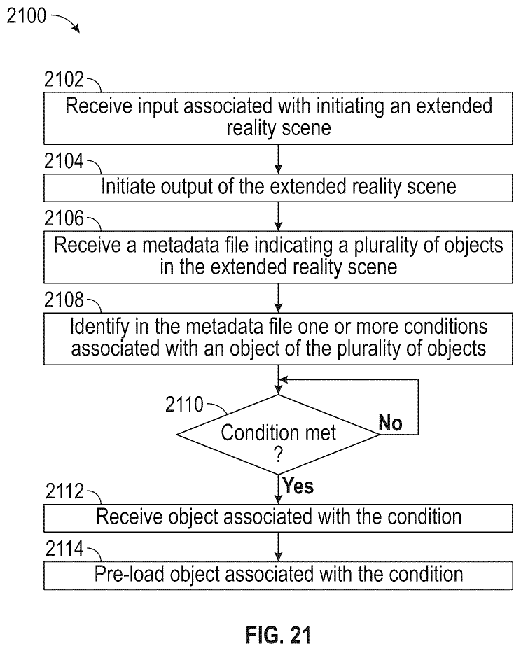

FIG. 21 shows another flowchart of illustrative steps for enabling extended reality content delivery, in accordance with some embodiments of the disclosure. Process 2100 may be implemented, in whole or in part, on any of the computing devices mentioned herein. In addition, one or more actions of the process 2100 may be incorporated into or combined with one or more actions of any other processes, embodiments or examples described herein.

At 2102, an input associated with initiating an extended reality scene is received at a computing device, and, at 2104, an output of the extended reality scene is initiated. At 2106, a metadata file indicating a plurality of objects in the extended reality scene is received. The metadata file indicates, for each object of a plurality of objects in the extended reality scene, a plurality of detail levels and a single-use classification or a multi-use classification. At 2108, one or more conditions associated with an object of the plurality of objects are identified in the metafile. At 2110, it is determined whether the condition is met. If the condition is not met, the process loops around until it is met. If, at 2110, it is determined that the condition is met, then the process proceeds to step 2112, where a single-use and/or multi-use object associated with the condition is received at a determined detail level, and, at 2114, the received object associated with the condition is pre-loaded.

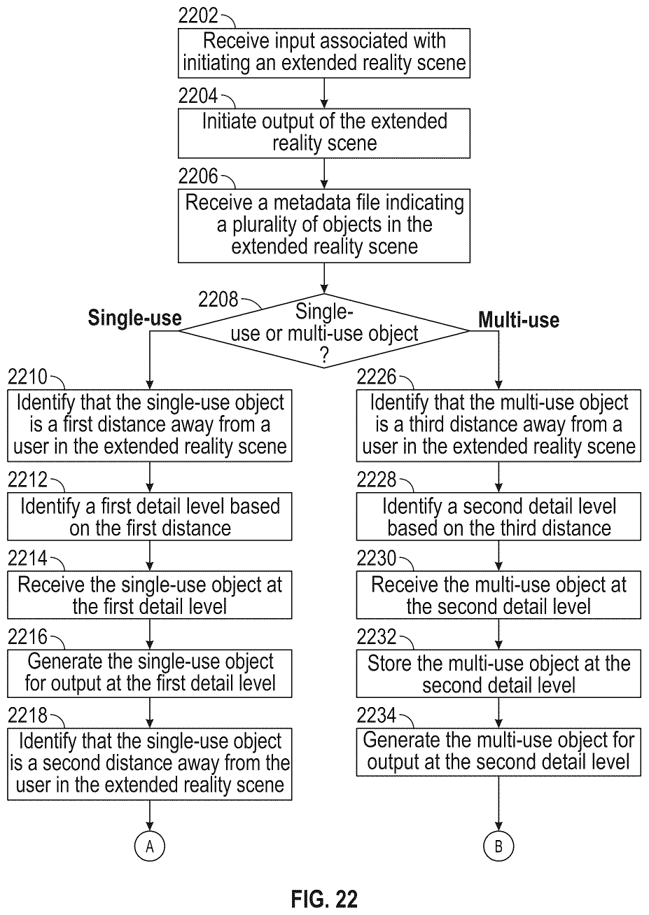

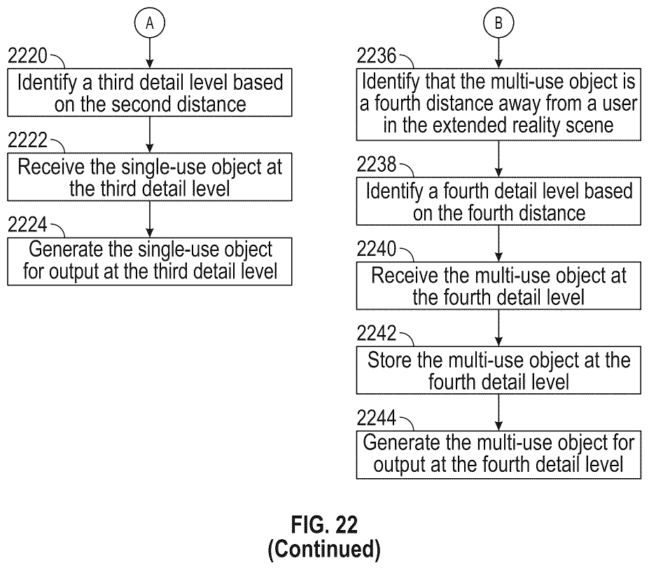

FIG. 22 shows another flowchart of illustrative steps for enabling extended reality content delivery, in accordance with some embodiments of the disclosure. Process 2200 may be implemented, in whole or in part, on any of the computing devices mentioned herein. In addition, one or more actions of the process 2200 may be incorporated into or combined with one or more actions of any other processes, embodiments or examples described herein.

At 2202, an input associated with initiating an extended reality scene is received at a computing device, and, at 2204, an output of the extended reality scene is initiated. At 2206, a metadata file indicating a plurality of objects in the extended reality scene is received. The metadata file indicates, for each object of a plurality of objects in the extended reality scene, a plurality of detail levels and a single-use classification or a multi-use classification. At 2208, it is determined whether the object is a single-use object or a multi-use object, for example, based on data in the received metadata file.

If, at 2208, it is determined that the object is a single-use object, then the process proceeds to 2210, where it is identified that the single-use object is a first distance away from a virtual representation of a user in the extended reality scene. At 2212, a first detail level is identified based on the first distance. For example, if the object is a relatively far distance away, then the first detail level may be relatively low. At 2214, the single-use object is received at the first detail level, and, at 2216, the single-use object is generated for output at the first detail level. At 2218, it is identified that the single-use object is a second distance away from a virtual representation of a user in the extended reality scene. For example, the object may now be relatively closer to the virtual representation of the user. At 2212, a third detail level is identified based on the second distance. For example, if the object is a relatively near distance away, then the first detail level may be relatively high. At 2214, the single-use object is received at the third detail level, and, at 2216, the single-use object is generated for output at the third detail level.

If, at 2208, it is determined that the object is a multi-use object, then the process proceeds to 2226, where it is identified that the multi-use object is a third distance away from a virtual representation of a user in the extended reality scene. At 2228, a second detail level is identified based on the third distance. For example, if the object is a relatively far distance away, then the first detail level may be relatively low. At 2230, the multi-use object is received at the second detail level, and, at 2232, the multi-use object is stored at the second detail level, for example, in a cache of the computing device. At 2234, the multi-use object is generated for output at the second detail level. At 2236, it is identified that the multi-use object is a fourth distance away from a virtual representation of a user in the extended reality scene. For example, the object may now be relatively closer to the virtual representation of the user. At 2238, a fourth detail level is identified based on the fourth distance. For example, if the object is a relatively near distance away, then the first detail level may be relatively high. At 2240, the multi-use object is received at the fourth detail level, and, at 2242, the multi-use object is stored at the fourth detail level, for example, in a cache of the computing device. At 2244, the multi-use object is generated for output at the fourth detail level.

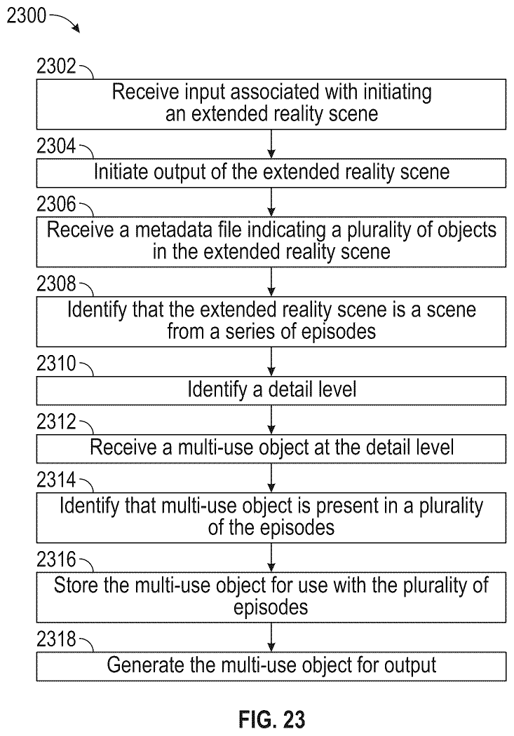

FIG. 23 shows another flowchart of illustrative steps for enabling extended reality content delivery, in accordance with some embodiments of the disclosure. Process 2300 may be implemented, in whole or in part, on any of the computing devices mentioned herein. In addition, one or more actions of the process 2300 may be incorporated into or combined with one or more actions of any other processes, embodiments or examples described herein.

At 2302, an input associated with initiating an extended reality scene is received at a computing device, and, at 2304, an output of the extended reality scene is initiated. At 2306, a metadata file indicating a plurality of objects in the extended reality scene is received. The metadata file indicates, for each object of a plurality of objects in the extended reality scene, a plurality of detail levels and a single-use classification or a multi-use classification. At 2308, it is identified that the extended reality scene is a scene from a series of episodes, and, at 2310, a detail level for a multi-use object is identified. At 2312, the multi-use object is received at the identified detail level, and, at 2314, it is identified that the multi-use object is present in a plurality of episodes of the series. At 2316, the multi-use object is stored, for example, in a cache at the computing device, for use with the plurality of episodes, and, at 2318, the multi-use object is generated for output.

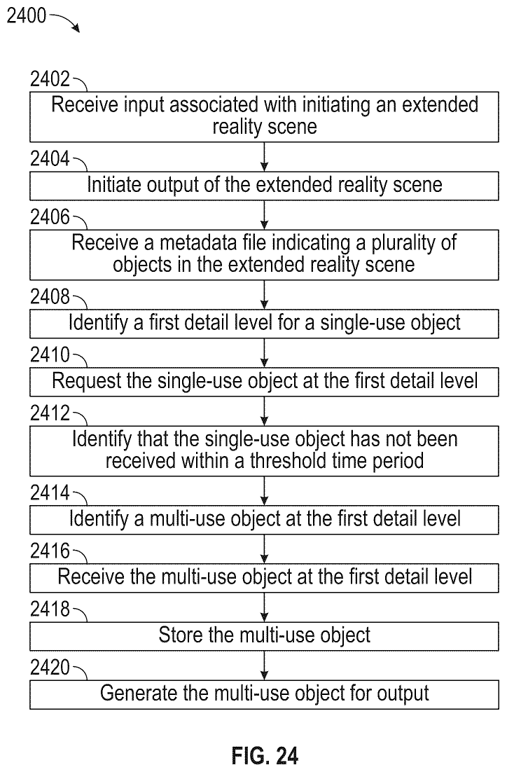

FIG. 24 shows another flowchart of illustrative steps for enabling extended reality content delivery, in accordance with some embodiments of the disclosure. Process 2400 may be implemented, in whole or in part, on any of the computing devices mentioned herein. In addition, one or more actions of the process 2400 may be incorporated into or combined with one or more actions of any other processes, embodiments or examples described herein.

At 2402, an input associated with initiating an extended reality scene is received at a computing device, and, at 2404, an output of the extended reality scene is initiated. At 2406, a metadata file indicating a plurality of objects in the extended reality scene is received. The metadata file indicates, for each object of a plurality of objects in the extended reality scene, a plurality of detail levels and a single-use classification or a multi-use classification. At 2408, a first detail level for a single-use object is identified, and, at 2410, the single-use object is requested at the first detail level. At 2412, it is identified that the single-use object has not been received within a threshold time period, and, at 2414, a multi-use object is identified at the first detail level. In some examples, the threshold time period may be based on when the object is predicted to be required in the extended reality scene and/or based on a typical loading time at the computing device. In some examples, a suitable multi-use object may be indicated in the metadata file. At 2416, the multi-use object is received at the first detail level, and, at 2418, the multi-use object is stored, for example, in a cache of the computing device. At 2420, the multi-use object is generated for output.

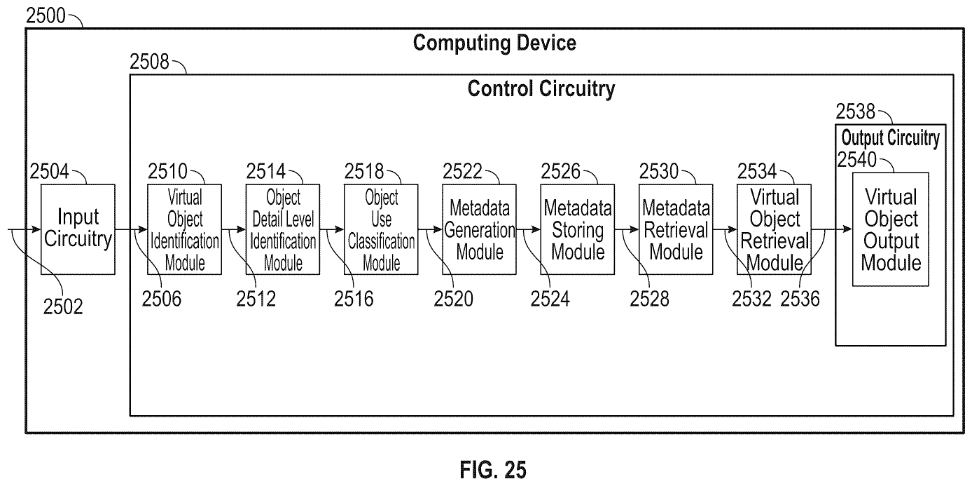

FIG. 25 shows a block diagram representing components of a computing device and dataflow therebetween for enabling extended reality content delivery, in accordance with some embodiments of the disclosure. Computing device 2500 comprises input circuitry 2504, control circuitry 2508 and output circuitry 2538. The computing device 2500 may be, for example, a server. Control circuitry 2508 may be based on any suitable processing circuitry (not shown) and comprises control circuits and memory circuits, which may be disposed on a single integrated circuit or may be discrete components and processing circuitry. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i9 processors) or multiple different processors (e.g., an Intel Core i5 processor and an Intel Core i7 processor) and/or a system on a chip (e.g., a Qualcomm Snapdragon 8 processor). Some control circuits may be implemented in hardware, firmware, or software.

First input is received 2502 by the input circuitry 2504. The input circuitry 2504 is configured to receive inputs related to a computing device. For example, this may be via a keyboard and a mouse. In other examples, the input may be received via a touchscreen, an infrared controller, a Bluetooth and/or Wi-Fi controller of the computing device 2500, and/or a microphone. In some examples, this may be via a gesture detected via an extended reality device. In a further example, the input may comprise instructions received via another computing device. The input circuitry 2504 transmits 2506 the user input to the control circuitry 2508.

The control circuitry 2508 comprises a virtual object identification module 2510, an object detail level identification module 2514, an object use classification module 2518, a metadata generation module 2522, a metadata storing module 2526, a metadata retrieval module 2530, a virtual object retrieval module 2534 and output circuitry 2538 comprising an virtual object output module 2540.

The first input is transmitted 2506 to the virtual object identification module 2510, where a plurality of virtual objects are identified, for example in an extended reality scene. An indication of the virtual objects is transmitted 2512 to the object detail level identification module 2514, where a detail level associated with each of the plurality of objects is identified. For example, the detail level may be identified based on a bandwidth available to the computing device 2500. The indication of the objects and the associated detail levels are transmitted 2516 to the object use classification module 2518, where it is identified whether the objects are, for example, single-use or multi-use. The indication of the objects, the associated detail levels and the object use are transmitted 2520 to the metadata generation module, where a metadata file is generated. The metadata file may indicate, for at least a subset of the plurality of objects, the plurality of detail levels, a location (e.g., a URL) of the object for each detail level of the plurality of detail levels and the object classification. The metadata file is transmitted 2524 to the metadata storing module 2526, where the metadata file is stored. An indication of the stored metadata file is transmitted 2528 to the metadata retrieval module 2530, where the metadata file is caused to be retrieved, for example, by a second computing device, such as an extended reality device. An indication that the metadata has been retrieved is transmitted 2532 to the virtual object retrieval module 2534, where the second computing device is caused to retrieve at least a subset of the plurality of virtual objects at a detail level of the plurality of detail levels. An indication is transmitted 2536 to the output circuitry 2538, where the subset of the plurality of virtual objects to be generated for output at the virtual object output module 2540.

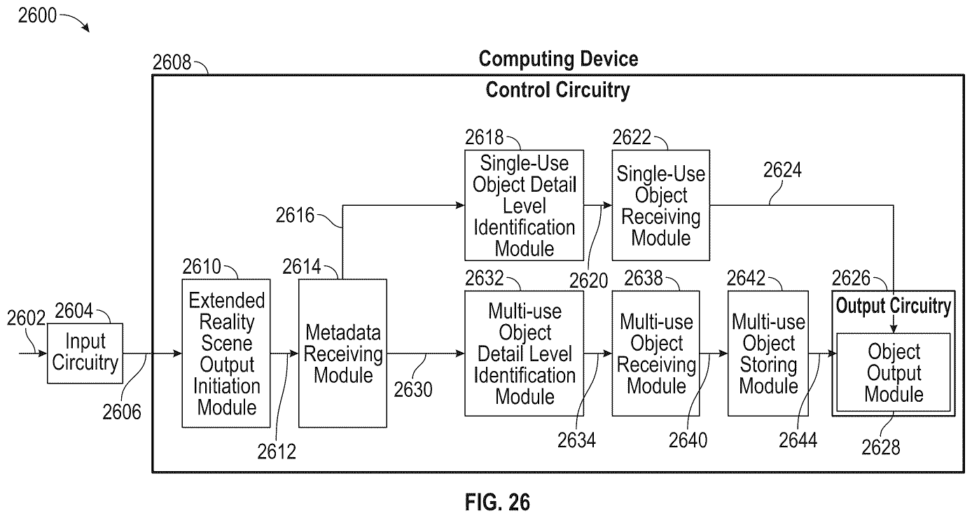

FIG. 26 shows another block diagram representing components of a computing device and dataflow therebetween for enabling extended reality content delivery, in accordance with some embodiments of the disclosure. Computing device 2600 comprises input circuitry 2604, control circuitry 2608 and output circuitry 2626. The computing device 2600 may be, for example, an extended reality device. Control circuitry 2608 may be based on any suitable processing circuitry (not shown) and comprises control circuits and memory circuits, which may be disposed on a single integrated circuit or may be discrete components and processing circuitry. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i9 processors) or multiple different processors (e.g., an Intel Core i5 processor and an Intel Core i7 processor) and/or a system on a chip (e.g., a Qualcomm Snapdragon 8 processor). Some control circuits may be implemented in hardware, firmware, or software.

First input is received 2602 by the input circuitry 2604. The input circuitry 2604 is configured to receive inputs related to a computing device. For example, this may be via a gesture detected via an extended reality device. In some examples, this may be via a keyboard and a mouse. In other examples, the input may be received via a touchscreen, an infrared controller, a Bluetooth and/or Wi-Fi controller of the computing device 2600, and/or a microphone. In a further example, the input may comprise instructions received via another computing device. The input circuitry 2604 transmits 2606 the user input to the control circuitry 2608.

The control circuitry 2608 comprises an extended reality scene output initiation module 2610, a metadata receiving module 2614, a single-use object detail level identification module 2618, a single-use object receiving module 2622, output circuitry 2626 comprising an object output module 2628, a multi-use object detail level identification module 2632, a multi-use object receiving module 2638 and a multi-use object storing module 2642.

The first input is transmitted 2606 to the extended reality scene output initiation module 2610, where the output of an extended reality scene is initiated, for example, at an extended reality device. An indication is transmitted 2612 to the metadata receiving module 2614, where a metadata file is received, for example, from a server. The metadata file may indicate a plurality of objects in the extended reality scene and, for each object of the plurality of objects, the metadata file may indicate a plurality of detail levels and a single-use classification or a multi-use classification.

For a single-use object, an indication is transmitted 2616 to the single-use object detail level identification module 2618, where a detail level associated with the object is identified. This detail level may, for example, be based on a bandwidth available to the extended reality device with a relatively low bandwidth, giving rise to a relatively low level of detail being identified for the object and a relatively high bandwidth, giving rise to a relatively high level of detail being identified for the object. An indication of the detail level is transmitted 2620 to the single-use object receiving module 2622, where the single-use object is received at the indicated detail level. The single-use object is transmitted 2624 to the output circuitry 2626, where the single-use object is output by the object output module 2628.

For a multi-use object, an indication is transmitted 2630 to the multi-use object detail level identification module 2632, where a detail level associated with the object is identified. This detail level may, for example, be based on a bandwidth available to the extended reality device with a relatively low bandwidth, giving rise to a relatively low level of detail being identified for the object and a relatively high bandwidth, giving rise to a relatively high level of detail being identified for the object. An indication of the detail level is transmitted 2634 to the multi-use object receiving module 2638, where the multi-use object is received at the indicated detail level. The multi-use object is transmitted 2640 to the multi-use object storing module 2642, where it is stored, for example, in a cache of the extended reality device. The multi-use object is transmitted 2644 from the multi-use object storing module 2642 to the output circuitry 2626, where the multi-use object is output by the object output module 2628.

The processes described above are intended to be illustrative and not limiting. One skilled in the art would appreciate that the steps of the processes discussed herein may be omitted, modified, combined, and/or rearranged, and any additional steps may be performed without departing from the scope of the disclosure. More generally, the above disclosure is meant to be illustrative and not limiting. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving, at a computing device, an input associated with initiating an extended reality scene;
initiating, at the computing device, output of the extended reality scene;
receiving, at the computing device, a metadata file indicating a plurality of objects in the extended reality scene, wherein the metadata file indicates for each object of the plurality of objects:
a plurality of detail levels; and
a single-use classification or a multi-use classification;
for a single-use object of the plurality of objects having the single-use classification:
identifying a first detail level of the plurality of detail levels;
receiving the single-use object at the first detail level; and
generating the single-use object for output at the first detail level;
for a multi-use object of the plurality of objects having the multi-use classification:
identifying a second detail level of the plurality of detail levels;
receiving the multi-use object at the second detail level;
storing, in a cache, the multi-use object at the second detail level; and
generating the multi-use object for output at the second detail level.

2. The method of claim 1, wherein the method further comprises:
identifying, based on a first bandwidth available to the computing device, the first detail level and the second detail level;
identifying an increase in the first bandwidth to a second bandwidth available to the computing device;
identifying, for the multi-use object and based on the increase in the first bandwidth, a third detail level of the plurality of detail levels, wherein the third detail level is higher than the second detail level;
receiving the multi-use object at the third detail level;
storing, in the cache, the multi-use object at the third detail level; and
generating the multi-use object for output at the third detail level.

3. The method of claim 1, wherein the computing device is a first computing device and the method further comprises:
receiving, at a second computing device, a manifest file for a content item comprising a plurality of segments;
receiving, at the second computing device, a segment of the plurality of segments;
generating, for output at the second computing device, the segment of the plurality of segments;
identifying, in the manifest file, one or more synchronization markers for synchronizing output of the plurality of segments of the content item and the single-use object and/or the multi-use object; and
outputting, at the second computing device, the plurality of segments of the content item synchronized with the outputting of the single-use object and/or the multi-use object.

4. The method of claim 1, wherein:
the method further comprises identifying an initiation of a trick-play mode;
identifying the first detail level further comprises identifying the first detail level based on the initiation of the trick-play mode; and
identifying the second detail level further comprises identifying the second detail level based on the initiation of the trick-play mode.

5. The method of claim 1, wherein the method further comprises:
identifying, in the metadata file, one or more conditions associated with an object of the plurality of objects;
identifying that a condition of the one or more conditions is met;
receiving the object associated with the condition; and
pre-loading the object associated with the condition.

6. The method of claim 1, wherein:
the method further comprises, at a first time, identifying that the single-use object is a first distance away from a user in the extended reality scene;
identifying the first detail level of the plurality of detail levels further comprises identifying the first detail level based on the first distance; and
the method further comprises:
at a second time, identifying that the single-use object is a second distance away from a user in the extended reality scene, wherein the second distance is less that the first distance;
identifying, for the single-use object and based on the second distance, a third detail level of the plurality of detail levels, wherein the third detail level is higher than the second detail level;
receiving the single-use object at the third detail level; and
generating the single-use object for output at the third detail level.

7. The method of claim 1, wherein the computing device is a first computing device, the cache is a first cache and the method further comprises:
causing a second computing device to join an extended reality session with the first computing device;
initiating, at the second computing device, output of the extended reality scene;
receiving, at the second computing device and from the first computing device, the metadata file;
for an object of the plurality of objects having the single-use classification:
identifying, at the first computing device, the first detail level of the plurality of detail levels;
receiving, from the first computing device, the single-use object at the first detail level; and
generating the single-use object for output, at the second computing device, at the first detail level;
for an object of the plurality of objects having the multi-use classification:
identifying, at the first computing device, the second detail level of the plurality of detail levels;
receiving, from the first computing device, the multi-use object at the second detail level;
storing, in a second cache at the second computing device, the multi-use object at the second detail level; and
generating the multi-use object for output, at the second computing device, at the second detail level.

8. The method of claim 7, wherein:
identifying the first detail level of the plurality of detail levels comprises identifying the first detail level based on a bandwidth available to the first computing device; and
identifying the second detail level of the plurality of detail levels comprises identifying the second detail level based on the bandwidth available to the first computing device.

9. The method of claim 1, wherein:
the method further comprises:
identifying that the extended reality scene is a scene from a series of episodes; and
identifying that the multi-use object is present in a plurality of episodes of the series of episodes; and
storing the multi-use object in the cache further comprises causing the multi-use object to be stored in the cache for use with the plurality of episodes of the series of episodes.

10. The method of claim 1, wherein the multi-use object is a first multi-use object and the method further comprises:
requesting the single-use object at the first detail level;
identifying that the single-use object has not been received within a threshold period of time;
identifying a second multi-use object at the first detail level; and
generating, for output, the second multi-use object in place of the single-use object.

11. A system comprising:
input/output circuitry configured to:
receive, at a computing device, an input associated with initiating an extended reality scene;
initiate, at the computing device, output of the extended reality scene; and
processing circuitry configured to:
receive, at the computing device, a metadata file indicating a plurality of objects in the extended reality scene, wherein the metadata file indicates for each object of the plurality of objects:
a plurality of detail levels; and
a single-use classification or a multi-use classification;
for a single-use object of the plurality of objects having the single-use classification:
identify a first detail level of the plurality of detail levels;
receive the single-use object at the first detail level; and
generate the single-use object for output at the first detail level;
for a multi-use object of the plurality of objects having the multi-use classification:
identify a second detail level of the plurality of detail levels;
receive the multi-use object at the second detail level;
store, in a cache, the multi-use object at the second detail level; and
generate the multi-use object for output at the second detail level.

12. The system of claim 11, wherein the processing circuitry is further configured to:
identify, based on a first bandwidth available to the computing device, the first detail level and the second detail level;
identify an increase in the first bandwidth to a second bandwidth available to the computing device;
identify, for the multi-use object and based on the increase in the first bandwidth, a third detail level of the plurality of detail levels, wherein the third detail level is higher than the second detail level;
receive the multi-use object at the third detail level;
store, in the cache, the multi-use object at the third detail level; and
generate the multi-use object for output at the third detail level.

13. The system of claim 11, wherein the computing device is a first computing device and the processing circuitry is further configured to:
receive, at a second computing device, a manifest file for a content item comprising a plurality of segments;
receive, at the second computing device, a segment of the plurality of segments;
generate, for output at the second computing device, the segment of the plurality of segments;
identify, in the manifest file, one or more synchronization markers for synchronizing output of the plurality of segments of the content item and the single-use object and/or the multi-use object; and
output, at the second computing device, the plurality of segments of the content item synchronized with the outputting of the single-use object and/or the multi-use object.

14. The system of claim 11, wherein:
the processing circuitry is further configured to identify an initiation of a trick-play mode;
the processing circuitry configured to identify the first detail level is further configured to identify the first detail level based on the initiation of the trick-play mode; and
the processing circuitry configured to identify the second detail level is further configured to identify the second detail level based on the initiation of the trick-play mode.

15. The system of claim 11, wherein the processing circuitry is further configured to:
identify, in the metadata file, one or more conditions associated with an object of the plurality of objects;
identify that a condition of the one or more conditions is met;
receive the object associated with the condition; and
pre-load the object associated with the condition.

16. The system of claim 11, wherein:
the processing circuitry is further configured to, at a first time, identify that the single-use object is a first distance away from a user in the extended reality scene;
the processing circuitry configured to identify the first detail level of the plurality of detail levels is further configured to identify the first detail level based on the first distance; and
the processing circuitry is further configured to:
at a second time, identify that the single-use object is a second distance away from a user in the extended reality scene, wherein the second distance is less that the first distance;
identify, for the single-use object and based on the second distance, a third detail level of the plurality of detail levels, wherein the third detail level is higher than the second detail level;
receive the single-use object at the third detail level; and
generate the single-use object for output at the third detail level.

17. The system of claim 11, wherein the computing device is a first computing device, the cache is a first cache and the processing circuitry is further configured to:
cause a second computing device to join an extended reality session with the first computing device;
initiate, at the second computing device, output of the extended reality scene;
receive, at the second computing device and from the first computing device, the metadata file;
for an object of the plurality of objects having the single-use classification:
identify, at the first computing device, the first detail level of the plurality of detail levels;
receive, from the first computing device, the single-use object at the first detail level; and
generate the single-use object for output, at the second computing device, at the first detail level;
for an object of the plurality of objects having the multi-use classification:
identify, at the first computing device, the second detail level of the plurality of detail levels;
receive, from the first computing device, the multi-use object at the second detail level;
store, in a second cache at the second computing device, the multi-use object at the second detail level; and
generate the multi-use object for output, at the second computing device, at the second detail level.

18. The system of claim 17, wherein:
the processing circuitry configured to identify the first detail level of the plurality of detail levels is further configured to identify the first detail level based on a bandwidth available to the first computing device; and
the processing circuitry configured to identify the second detail level of the plurality of detail levels is further configured to identify the second detail level based on the bandwidth available to the first computing device.

19. The system of claim 11, wherein:
the processing circuitry is further configured to:
identify that the extended reality scene is a scene from a series of episodes; and
identify that the multi-use object is present in a plurality of episodes of the series of episodes; and
the processing circuitry configured to store the multi-use object in the cache is further configured to cause the multi-use object to be stored in the cache for use with the plurality of episodes of the series of episodes.

20. The system of claim 11, wherein the multi-use object is a first multi-use object and the processing circuitry is further configured to:
request the single-use object at the first detail level;
identify that the single-use object has not been received within a threshold period of time;
identify a second multi-use object at the first detail level; and
generate, for output, the second multi-use object in place of the single-use object.

21-50. (canceled)
